(19) United States
(12) Patent Application Publication
(10) Pub. No.: US 2009/0013446 A1
(43) Pub. Date: Jan. 15, 2009

(54) ELASTOMERIC ITEMS WITH DESIRABLE STRENGTH AND COMFORT PROPERTIES

(75) Inventors: Kevin Grant Suddaby, Morrisville, NC (US); Neil Douglas Redpath, Raleigh, NC (US); Alicia Lee Sellers, Durham, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Dow Reichhold Specialty Latex, LLC, Durham, NC (US)

(21) Appl. No.: 12/171,017

(22) Filed: Jul. 10, 2008

Related U.S. Application Data
(60) Provisional application No. 60/959,066, filed on Jul. 11, 2007.

(51) Int. Cl. A41D 19/00; C08F 136/06; B32B 27/32

(52) U.S. Cl. 2/167; 526/335; 428/220

(57) ABSTRACT

A test for determining whether an elastomeric article has a desired ratio of strength to comfort, i.e., a strength-comfort index, is disclosed. Methods for preparing strong, soft, and thin articles from synthetic latexes, to optimize the strength and comfort of the articles, are also disclosed. Using this index, and, optionally, comparing the results with those one obtained using natural rubber, one can determine whether an article of manufacture can be prepared from synthetic elastomers and still have optimal properties (i.e., strength and comfort), particularly as compared to a similar article prepared from natural rubber. The strength of an article is directly related to the force required to break a tensile specimen of the sample and thus the tensile strength of the article. A measure of the strength of an article relative to its resistance to deformation is given by the following ratio:

$$\frac{{T}_{b}}{{T}_{x} \times {t}_{0}}$$

where T_{b} is the tensile strength of the article, Tₓ is the tensile stress at x % elongation, t₀ is the thickness of the unstrained specimen, and T_{b}, Tₓ, and t₀ are all measured following ASTM D-412. This ratio is defined herein as the strength-comfort index.

### REFERENCE TO RELATED APPLICATION

This application claims the benefit of U.S.S.N. 60/959,066, filed on Jul. 11, 2007, the contents of which are hereby incorporated by reference.

### FIELD OF THE INVENTION

The present invention relates to compositions and processes useful in making elastomeric articles of manufacture, for example, rubber gloves. More particularly, the compositions and processes yield synthetic rubber articles of manufacture with high strength and comfort properties similar to those produced from natural rubber.

### BACKGROUND OF THE INVENTION

Articles of manufacture such as gloves, condoms, bags, and the like are generally formed from latex polymeric materials, and are useful in a wide variety of applications relating to for example, medical, industrial and household uses. Latex gloves are one example of such articles of manufacture. Latex gloves are preferred over other materials since they can be made light, thin, flexible, tight-fitting, and substantially impermeable to a variety of liquids and gases. It is often desirable that the gloves possess adequate physical properties such as high tensile strength, high force at break, and high elongation at break. It is also desirable that the glove be comfortable for the wearer.

Conventional latex gloves have typically been formed from natural rubber, primarily due to the combination of desirable physical properties and comfort that can be obtained with natural rubber. Nonetheless, many wearers of such gloves are susceptible to allergic reactions to proteins found in natural rubber. These individuals often experience difficulty when wearing the gloves. As a result there have been efforts to develop gloves made from synthetic materials which are comparable to the natural rubber gloves in terms of comfort and various physical properties. One synthetic alternative focuses on the use of poly(vinylchloride) (PVC). PVC gloves are undesirable in many respects. PVC is typically plasticized in order to be pliable enough for glove applications, and PVC gloves do not possess the combination of high tensile strength, high force at break, high elongation at break and comfort that are desirable in gloves.

U.S. Pat. No. 6,369,154, U.S. Re. 35616, U.S. Pat. No. 6,624,274, and U.S. Pat. No. 6,627,325, each incorporated by reference with regard to a background understanding, teach a range of different synthetic elastomers that can be used to make gloves. While these address many of the physical property requirements of gloves and the protein allergy issue associated with natural rubber latex, there continues to be a need for articles of manufacture derived from synthetic elastomers having a combination of desirable physical properties and comfort similar to that of natural rubber latex.

A number of different standards exist for physical properties of elastomeric articles of manufacture. For example, when the elastomeric articles of manufacture are gloves, there are various ASTM and other standards for evaluating the performance of the gloves. Representative standards include ASTM D 3578, “Standard Specification for Rubber Surgical Gloves”, ASTM D 3577, “Standard Specification for Rubber Examination Gloves”, ASTM D 6319, “Standard Specification for Nitrile Examination Gloves for Medical Application”, and EN 455-2, “Medical gloves for single use. Requirements and testing for physical properties”. Each of these standards are herein incorporated in their entirety. However, these standards do not evaluate the comfort of elastomeric articles of manufacture.

It would be advantageous to provide a method to evaluate synthetic latex materials for their ability to form elastomeric articles of manufacture with suitable strength and comfort properties, so they could approximate or surpass those of natural rubber. The present invention provides such a method, and articles of manufacture produced from the materials.

### SUMMARY OF THE INVENTION

A test for determining whether an elastomeric article has a desired ratio of strength to comfort, i.e., a strength-comfort index, is disclosed. Methods for preparing strong, soft, and thin articles from synthetic latexes, to optimize the strength and comfort of the articles, are also disclosed.

Using this index, and, optionally, comparing the results with those one obtained using natural rubber, one can determine whether an article of manufacture can be prepared from synthetic elastomers and still have optimal properties (i.e., strength and comfort), particularly as compared to a similar article prepared from natural rubber.

The strength of an article is directly related to the force required to break a tensile specimen of the sample and thus the tensile strength of the article.

A measure of the tensile strength of an article relative to its resistance to deformation is given by the following ratio:

$$\frac{{T}_{b}}{{T}_{x} \times {t}_{0}}$$

where T_{b} is the tensile strength of the article, Tₓ is the tensile stress at x % elongation, and t₀ is the thickness of the unstrained specimen. T_{b}, Tₓ, and to are all measured following ASTM D-412. This ratio is high for thin (low t₀), compliant (low Tₓ) articles with high strength (high T_{b}) and low for thick (high t₀), stiff (high Tₓ) articles with low strength (low T_{b}).

The strength-comfort index is defined below:

$${SCI}_{x} = \frac{{T}_{b}}{{T}_{x} \times {t}_{0}}$$

where SCIₓ is the strength-comfort index based on the tensile stress at x % elongation. Using SI units, SCIₓ will have units of mm⁻¹.

Natural rubber latex is well known to those skilled in the art for its utility in making strong soft thin dipped goods. Using the index, one can tailor synthetic lattices, the manner in which they are made, and the manner in which they are formed into articles of manufacture, to provide strong, soft, and thin dipped goods such as gloves and condoms with strength-comfort indices approximating those of analogous dipped goods made from natural rubber.

Thus, one aspect of the present invention includes an article of manufacture comprising a synthetic elastomer, wherein the article of manufacture possesses a SCI₁₀₀ greater than or equal to about 190 mm⁻¹,

wherein the SCI₁₀₀ value is calculated by measuring the tensile strength of an article relative to its resistance to deformation according to the ratio:

$$\frac{{T}_{b}}{{T}_{x} \times {t}_{0}}$$

where T_{b} is the tensile strength of the article, Tₓ is the tensile stress at x % elongation, x is 100, and t₀ is the thickness of the unstrained specimen, T_{b}, Tₓ, and t₀ are all measured following ASTM D-412, and the strength-comfort index, or SCIₓ, is defined as:

$${SCI}_{x} = \frac{{T}_{b}}{{T}_{x} \times {t}_{0}} .$$

In one embodiment, the article of manufacture possesses a SCI₁₀₀ greater than or equal to about 200 mm⁻¹, preferably about 225 mm⁻¹, or further preferably about 250 mm⁻¹. In one embodiment, the synthetic elastomer is prepared as an aqueous dispersion. In one embodiment, the synthetic elastomer is prepared by emulsion polymerization. In one embodiment, the synthetic elastomer comprises a C₄ to C₉ diene. In one embodiment, the synthetic elastomer is prepared from a monomer mixture comprising 1,3-butadiene. In one embodiment, the synthetic elastomer is prepared from a monomer mixture comprising acrylonitrile. In one embodiment, the thickness of the article is less than or equal to about 0.09 mm. In one embodiment, the tensile strength is measured from a sample cut from Die C or Die D as specified in ASTM D-412. In one embodiment, the article is made using a dipping process. In one embodiment, the article is a glove. In one embodiment, the article possesses a tensile strength greater than or equal to 14 MPa and an ultimate elongation of greater than or equal to 500% when measured following ASTM D-412. In one embodiment, the article possesses a force at break greater than or equal to 9 N when measured following EN 455-2.

Another aspect of the present invention includes a method of preparing a synthetic polymer film with a SCI₁₀₀ greater than 190 mm⁻¹, comprising:
a) identifying a polymer composition or set of polymer compositions that can be compounded to provide various values for tensile strength and tensile stress, and
b) preparing polymer films that balance the tensile strength, tensile stress, and film thickness, optionally by adjusting the compounding and processing conditions to which the polymer composition or set of polymer compositions is subjected, such that the SCI₁₀₀ has a value greater than or equal to 190 mm⁻¹, wherein the SCI₁₀₀ value is calculated by measuring the tensile strength of an article relative to its resistance to deformation according to the ratio:

$$\frac{{T}_{b}}{{T}_{x} \times {t}_{0}}$$

where T_{b} is the tensile strength of the article, Tₓ is the tensile stress at x % elongation, x is 100, and t₀ is the thickness of the unstrained specimen, T_{b}, Tₓ, and t₀ are all measured following ASTM D-412, and the strength-comfort index, or SCIₓ, is defined as:

$${SCI}_{x} = \frac{{T}_{b}}{{T}_{x} \times {t}_{0}} .$$

In one embodiment, the polymer film possesses a SCI₁₀₀ greater than or equal to about 200 mm⁻¹. In one embodiment, the polymer film possesses a SCI₁₀₀ greater than or equal to about 225 mm⁻¹. In one embodiment, the polymer film possesses a SCI₁₀₀ greater than or equal to about 250 mm⁻¹. In one embodiment, the method of the present invention includes:
a) using an unglazed smooth surface ceramic glove former;
b) heating said glove former to a temperature of between about 70 and about 120° C. followed by dipping the heated glove former into an aqueous coagulant comprising about 20-about 35% calcium nitrate, and removing the glove former from the coagulant with an exit speed between about 2 and about 30 mm/s; and
   drying the glove former wet with coagulant at about 70-about 120° C. for about 30-about 60 seconds, followed by dipping the former into a carboxylated nitrile latex compound with an entry speed of about 15-about 100 mm/s, a dwell time of 0-about 10 seconds, and an exit speed of about 15-about 30 mm/s, wherein said carboxylated nitrile latex compound has a pH of above about 8.8, a non-volatile content of about 15-about 30%, comprises about 0.6-about 1 phr zinc oxide, and a temperature of about 15-about 40° C.

The scope of the present invention includes any combination of embodiments, aspects, and preferences herein described.

### BRIEF DESCRIPTION OF THE DRAWINGS

FIG. 1 is a graphical illustration of the strength comfort index at 25% elongation (SCI₂₅(mm⁻¹)) as demonstrated by a variety of gloves as herein described.

FIG. 2 is a graphical illustration of the strength comfort index at 50% elongation (SCI₅₀(mm⁻¹)) as demonstrated by a variety of gloves as herein described.

FIG. 3 is a graphical illustration of the strength comfort index at 100% elongation (SCI₁₀₀(mm⁻¹)) as demonstrated by a variety of gloves as herein described.

### DETAILED DESCRIPTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

Natural rubber latex is well known to those skilled in the art for its utility in making strong soft thin dipped goods. To satisfy the need for strong, soft, and thin dipped goods prepared from synthetic latexes, the strength-comfort index described herein was developed to identify suitable polymer lattices, and the manner in which they are made and formed into articles of manufacture, to provide such strong, soft, and thin articles.

### I. The Strength-Comfort Index

The comfort of an article of manufacture such as a glove is strongly and inversely related to its resistance to deformation. Modulus, or tensile stress, is the amount of pull required to stretch a test specimen to a given elongation expressed in force per unit cross-sectional area of the unstrained specimen; a measure of the stiffness or resistance to deformation of the material. The cross-sectional area component normalizes the tensile stress measurement for the sample dimensions making it a material property, as opposed to a property dependent on the specific dimensions of the article. Multiplying the tensile stress by the thickness of the unstrained sample will yield the force per unit width required to obtain the given elongation. This is a more appropriate measure of resistance to deformation since the resistance of an article to deformation will be proportional to its thickness.

The strength of an article is directly related to the force required to break a tensile specimen of the sample and thus the tensile strength of the article.

A measure of the strength of an article relative to its resistance to deformation is given by the following ratio:

$$\frac{{T}_{b}}{{T}_{x} \times {t}_{0}}$$

where T_{b} is the tensile strength of the article, Tₓ is the tensile stress at x % elongation, and t₀ is the thickness of the unstrained specimen. T_{b}, Tₓ, and to are all measured following ASTM D-412, which is herein incorporated by reference in its entirety. This ratio is high for thin (low t₀), compliant (low Tₓ) articles with high strength (high T_{b}) and low for thick (high t₀), stiff (high Tₓ) articles with low strength (low T_{b}).

The strength-comfort index is defined below:

$${SCI}_{x} = \frac{{T}_{b}}{{T}_{x} \times {t}_{0}}$$

where SCIₓ is the strength-comfort index based on the tensile stress at x % elongation. Using SI units, SCIₓ will have units of mm⁻¹.

The tensile stresses at very low elongations can be difficult to measure. Furthermore, the tensile stress values at very high elongations generally are inadequate as components of comfort since high elongations are infrequently encountered in normal use. For these reasons the use of SCI₁₀₀ may be preferred, although one skilled in the art will recognize that the strength comfort index based on the tensile stress at other elongations can be used, for example, SCI₅₀ and SCI₂₅. Those of skill in the art can readily select a suitable strength comfort index range based on the tensile stress at elongations other than the embodiment that is herein exemplified, namely 100% elongation.

Ideally, articles of manufacture such as gloves will have a strength-comfort index at 100% elongation (SCI₁₀₀) greater than about 190 mm⁻¹, preferably, greater than about 200 mm⁻¹, more preferably, greater than about 225 mm⁻¹, and still more preferably, greater than about 250 mm⁻¹, where the article of manufacture approximates the results found with natural rubber. The analogous strength-comfort indices at other elongations can readily be determined upon selection of a desired elongation.

In one embodiment, the articles of manufacture have a tensile strength greater than or equal to 14 MPa and an ultimate elongation of greater than or equal to 500% when measured following ASTM D-412, herein incorporated by reference in its entirety. In another embodiment, the articles of manufacture have a force at break greater than or equal to 9 N when measured following EN 455-2, herein incorporated by reference in its entirety.

It may be desirable in some situations to make an article of manufacture thinner and to increase the comfort level, if the overall ratio of strength/comfort is not adversely affected. That is, provided the article of manufacture has adequate strength for its intended application with the lesser thickness, and the comfort can be increased to a more desirable level, decreasing the thickness may be desirable. In some embodiments, the thickness of the article is less than or equal to about 0.09 mm.

### II. Polymer Latices

Virtually all elastomers, including those prepared from polymer lattices, can be evaluated for use in preparing articles of manufacture with desirable strength-comfort indices. In some embodiments, the elastomers are already known, but their use in preparing articles of manufacture that are relatively thin, or the manner in which the elastomers are made, such as to maximize their strength, may not have been known. Thus, using the strength-comfort index described herein, dipped goods prepared from various elastomer compositions can be evaluated at different thicknesses, and they can be prepared using different processing and compounding conditions, such that these properties can be optimized to approximate or exceed those of natural rubber.

In one embodiment, the latex composition used to prepare the articles of manufacture include from about 35 to 80 weight percent, preferably from about 45 to about 70 weight percent of aliphatic conjugated diene monomer, from about 10 to about 65 weight percent, preferably from about 20 to about 50 weight percent of unsaturated aromatic, nitrile, ester or amide monomer, and above 0 to about 15 weight percent, preferably about 2 to 7 weight percent of unsaturated acid monomer. Blends or copolymers of the monomers may be used.

Suitable conjugated diene monomers that may be used include, but are not limited to C₄₋₉ dienes such as, for example, butadiene monomers such as 1,3-butadiene, 2-methyl-1,3-butadiene, and the like. Blends or copolymers of the diene monomers can also be used. A particularly preferred conjugated diene is 1,3-butadiene.

The unsaturated aromatic, nitrile, ester, or amide monomers which may be used are well known and include, for example, styrene, (meth)acrylonitrile, acrylates, methacrylates, acrylamides and methacrylamides and derivatives thereof.

For the purposes of the invention, the term “aromatic monomer” is to be broadly interpreted and include, for example, aryl and heterocyclic monomers. Exemplary aromatic vinyl monomers which may be employed in the polymer latex composition include styrene and styrene derivatives such as alpha-methyl styrene, p-methyl styrene, vinyl toluene, ethylstyrene, tert-butyl styrene, monochlorostyrene, dichlorostyrene, vinyl benzyl chloride, vinyl pyridine, vinyl naphthalene, fluorostyrene, alkoxystyrenes (e.g., p-methoxystyrene), and the like, along with blends and mixtures thereof.

Nitrile monomers which may be employed include, for example, acrylonitrile, fumaronitrile and methacrylonitrile. Blends and mixtures of the above may be used.

The acrylic and methacrylic acid derivatives may include functional groups such as amino groups, hydroxy groups, epoxy groups and the like. Exemplary acrylates and methacrylates include, but are not limited to, various (meth)acrylate derivatives including, methyl methacrylate, ethyl methacrylate, butyl methacrylate, glycidyl methacrylate, hydroxyethyl methacrylate, hydroxypropyl methacrylate, hydroxybutyl methacrylate, 3-chloro-2-hydroxybutyl methacrylate, 2-ethylhexl(meth)acrylate, dimethylaminoethyl(meth)acrylate and their salts, diethylaminoethyl(meth)acrylate and their salts, acetoacetoxyethyl(meth)acrylate, 2-sulfoethyl (meth)acrylate and their salts, methoxy polyethylene glycol mono(meth)acrylate, polypropylene glycol mono(meth)acrylate, tertiarybutyl aminoethyl (meth)acrylate and their salts, benzyl(meth)acrylate, 2-phenoxyethyl(meth)acrylate, gamma-methacryloxypropyltrimethoxysilane, propyl(meth)acrylate, isopropyl(meth)acrylate, isobutyl (meth)acrylate, tertiarybutyl (meth)acrylate, isobornyl (meth)acrylate, isodecyl(meth)acrylate, cyclohexyl(meth)acrylate, lauryl(meth)acrylate, methoxyethyl (meth)acrylate, hexyl (meth)acrylate, stearyl(meth)acrylate, tetrahydrofufuryl(meth)acrylate, 2(2-ethoxyethoxy), ethyl(meth)acrylate, tridecyl (meth)acrylate, caprolactone(meth)acrylate, ethoxylated nonylphenol(meth)acrylate, propoxylated allyl(meth)acrylate and the like. Other acrylates include methyl acrylate, ethyl acrylate, butyl acrylate, glycidyl acrylate, hydroxyethyl acrylate, hydroxypropyl acrylate, and hydroxybutyl acrylate.

Exemplary (meth)acrylamide derivatives include, but are not limited to, acrylamide, N-methyolacrylamide, N-methyolmethacrylamide, 2-acrylamido-2-methylpropanesesulfonic acid, methacrylamide, N-isopropylacrylamide, tert-butylacrylamide, N-N′-methylene-bis-acrylamide, N,N-dimethylacrylamide, methyl-(acrylamido) glycolate, N-(2,2 dimethoxy-1-hydroxyethyl) acrylamide, acrylamidoglycolic acid, alkylated N-methylolacrylamides such as N-methoxymethylacrylamide and N-butoxymethylacrylamide

Suitable dicarboxylic ester monomers may also be used such as, for example, alkyl and dialkyl fumarates, itaconates and maleates, with the alkyl group having one to eight carbons, with or without functional groups. Specific monomers include diethyl and dimethyl fumarates, itaconates and maleates. Other suitable ester monomers include di(ethylene glycol) maleate, di(ethylene glycol) itaconate, bis(2-hydroxyethyl) maleate, 2-hydroxyethyl methyl fumarate, and the like. The mono and dicarboxylic acid ester and amide monomers may be blended or copolymerized with each other.

Ester and amide monomers which may be used in the polymer latex composition also include, for example, partial esters and amides of unsaturated polycarboxylic acid monomers. These monomers typically include unsaturated di- or higher acid monomers in which at least one of the carboxylic groups is esterified or aminated. One example of this class of monomers is of the formula RXOC—CH═CH—COOH wherein R is a C₁ to C₁₈ aliphatic, alicyclic or aromatic group, and X is an oxygen atom or a NR′ group where R′ represents a hydrogen atom or R group as herein defined. Examples include, but are not limited to, monomethyl maleate, monobutyl maleate, and monooctyl maleate. Partial esters or amides of itaconic acid having C₁ to C₁₈ aliphatic, alicyclic or aromatic groups such as monomethyl itaconate can also be used. Other mono esters, such as those in which R in the above formula is an oxyalkylene chain can also be used. Blends or copolymers of the partial esters and amides of the unsaturated polycarboxylic acid monomer can also be used.

A number of unsaturated acid monomers may be used in the polymer latex composition. Exemplary monomers of this type include, but are not limited to, unsaturated mono- or dicarboxylic acid monomers such as acrylic acid, methacrylic acid, itaconic acid, fumaric acid, maleic acid, and the like. Derivatives, blends, and mixtures of the above may be used. Methacrylic acid is preferably used. Partial esters and amides of unsaturated polycarboxylic acids in which at least one carboxylic group has been esterfied or aminated may also be used.

In one embodiment, the latex composition is devoid of styrene and its derivatives. In another embodiment, the latex composition is devoid of acrylonitrile and its derivatives. In yet another embodiment, the latex composition is devoid of chloroprene, and its derivatives. In accordance with another embodiment, the polymer latex composition may include additional unsaturated monomers. The additional unsaturated monomer may be employed for several reasons. For example, the additional monomers may aid in processing, more specifically, to help to reduce the time of polymerization of the latex. The presence of the additional unsaturated monomer may also help in enhancing the physical properties of a film, glove, or other article containing the polymer latex composition. A number of unsaturated monomers may be used and are well known to the skilled artisan.

The polymer latex composition may also include other components such as, for example, urethanes, epoxies, styrenic resins, acrylic resins, melamine-formaldehyde resins, and conjugated diene polymers (e.g., polybutadiene, styrene-butadine rubbers, nitrile butadiene rubbers, polyisoprene, and polychloroprene). Blends, derivatives, and mixtures thereof may also be used.

Conventional surfactants and emulsifying agents can be employed in the polymer latex composition. Polymerizable surfactants that can be incorporated into the latex also can be used. For example, anionic surfactants can be selected from the broad class of sulfonates, sulfates, ethersulfates, sulfosuccinates, and the like, the selection of which will be readily apparent to anyone skilled in the art. Nonionic surfactants may also be used to improve film and glove characteristics, and may be selected from the family of alkylphenoxypoly(ethyleneoxy)ethanols, where the alkyl group typically varies from C₇-C₁₈ and the ethylene oxide units vary from 4-100 moles. Various preferred surfactants in this class include the ethoxylated octyl and nonyl phenols. Ethoxylated alcohols are also desirable surfactants. A typical anionic surfactant is selected from the diphenyloxide disulfonate family, such as disodium dodecyl(sulphonatophenoxy)benzenesulfonate. In addition to, or in place of, the surfactants, a polymeric stabilizer may be used in the composition of the invention.

The polymer can include crosslinking agents and other additives, the selection of which will be readily apparent to one skilled in the art. Exemplary crosslinking agents include vinylic compounds (e.g., divinyl benzene); allyllic compounds (e.g., allyl methacrylate, diallyl maleate); and multifunctional acrylates (e.g., di, tri and tetra (meth)acrylates), sulfur, metal complexes, metal salts, and metal oxides (e.g., zinc oxide). Peroxides may also be used. Additional ingredients which may be used include, but are not limited to, chelating agents (e.g., ethylendiaminetetraacetic acid), dispersants (e.g., salts of condensed naphthalenesulfonic acid); buffering agents (e.g., ammonium hydroxide); and polymerization inhibitors (e.g., hydroquinone). Chain transfer agents (e.g., carbon tetrachloride, butyl mercaptan, bromotrichloromethane and t-dodecyl mercaptan) may also be used in the invention, preferably less than about 2 percent based on the weight of the monomers. More preferably, the chain transfer agent is used from about 0.0 to about 1.5 weight percent, and most preferably from about 0.3 to about 1.0 weight percent.

The monomers used in forming the polymer latex composition of the invention may be polymerized in a manner known to those who are skilled in the art. For example, the monomers may be polymerized at a temperature preferably between about 5° C. and 95° C., and more preferably between about 10° C. and 70° C.

### III. Representative Polymerization Techniques

Techniques for polymerizing monomers to form polymer lattices are well known to those of skill in the art. In some embodiments, the synthetic elastomers are prepared by emulsion polymerization, and in others, by solution polymerization.

Depending on the particular polymerization techniques employed, the thickness of the polymer films, and other factors, a similar monomer mixture can provide articles of manufacture with different strength/comfort ratios.

Using the techniques described herein, and measuring the various properties of the polymer films, those of skill in the art can identify monomer mixtures, polymerization techniques, and optimal film thicknesses, to prepare articles of manufacture from synthetic elastomers with strength and comfort approximating or even surpassing that of natural rubber.

### IV. Polymer Compounding

Techniques for compounding polymers are well known to those of skill in the art. In some embodiments, the synthetic polymer latexes are used. The compounding of a synthetic latex can influence its response to processing conditions, and the properties of the articles prepared from the synthetic polymer latex.

Factors such as solids content, the level of curing agents, and pH can influence the deposition rate (and thus thickness) of latex compounds during coagulant dipping processes. The level of curing agents and pH can also influence the physical properties (e.g. tensile strength, tensile stress, and strain at break) of cured films from the coagulant dipped latexes.

Those of skill in the art can readily modify the compounding conditions to provide polymer latex films with different physical properties, even with the same monomer composition.

### VI. Representative Dipping Techniques

Dipping techniques for latex articles of manufacture are well known to those of skill in the art. The gloves or other dipped articles are typically prepared, for example, by dipping a glove form (or other suitable form) into a latex mixture, curing the latex mixture on the glove form at elevated temperatures, and then stripping the cured latex glove from the glove form.

Glove forms can be prepared by washing with a detergent and rinsing. In some embodiments, the glove forms are dipped in a coagulant mixture that includes calcium nitrate, water, and a nonionic surfactant to promote congealing of the latex around the glove forms, particularly where the latex includes carboxylic acid groups or other ionically crosslinkable groups. In these embodiments, after being dipped in the coagulant mixture, the glove forms can be dipped in the latex material. The latex coated glove forms can then be dipped in a leach that includes warm water. The latex coated glove forms can then be dipped into a powder slurry that includes a suitable powder, including but not limited to powdered starch or talcum powder. Alternatively, the latex coated glove forms can be subjected to surface treatments such as chlorination or polymeric overdips as known to one skilled in the art to produce powder-free gloves.

The latex coated glove forms can be placed in an oven for a suitable period of time, for example, 30 minutes, at a suitable temperature, for example, 285 degrees Fahrenheit, to form a crosslinked polymer film in the shape of a glove. After removal from the oven, the crosslinked polymer film, while still on the form, can be dipped in a post curing leach, for example, a bath of warm water. The crosslinked polymer film can be subjected to surface treatments such as chlorination or polymeric overdips as known to one skilled in the art to produce powder-free gloves. The cured latex gloves can then be stripped from the glove forms and tumbled.

Other conditions for preparing dipped articles are well known to those of skill in the art. As discussed above, by optimizing the dipping techniques namely, to arrive at suitable film thicknesses, and the polymerization and compounding techniques namely, to produce films with suitable strength levels and tensile stress, one can produce articles of manufacture with desirable strength-comfort indices.

### VII. Optimization of Polymer Latex Compositions

The strength-comfort index can be used to optimize polymer latex compositions, and the resulting films formed from the polymers, to provide optimum properties. For example, once equipped with the strength-comfort index, one can develop a set of data points for a given monomer composition, wherein the composition is polymerized under different conditions, and dipped under different conditions, to provide maximum strength and/or maximum thinness, thus optimizing the strength-comfort index. A series of polymer compositions, compound compositions, and processing conditions can be analyzed as herein described, and the optimum ones identified.

### VIII. Representative Articles of Manufacture

Films formed from the polymer latex compositions described herein can be prepared, and formed into numerous articles of manufacture. Such latex articles generally include those which are typically made from natural rubber and which contact the human body, for example, gloves and condoms. Particularly with respect to these articles of manufacture, strength and comfort are very important aspects, and it is desirable for the articles of manufacture to be relatively thin. This tends to minimize their strength, which is acceptable so long as there is suitable strength for the intended purpose. However, this also tends to maximize their comfort, which is desirable.

Generally speaking, the articles of manufacture are characterized by being substantially impermeable to water vapor and liquid water.

Provided that the thickness of the articles of manufacture is sufficiently low, the strength of the polymer film is sufficiently high, and the tensile stress is sufficiently low, the resulting articles of manufacture, such as gloves, for example, surgical gloves, have a desirable blend of strength and comfort.

The present invention will be better understood with respect to the following non-limiting examples. As comparative examples, a series of commercially available gloves of made from a variety of different glove materials were obtained and their tensile properties evaluated.

### EXAMPLES 1-5 AND COMPARATIVE EXAMPLES 1-29

### Comparative Testing of the Strength-Comfort Index of Commercially-Available Gloves

As comparative examples, a series of commercially available gloves, representing a variety of different glove materials, were obtained and their tensile properties were evaluated.

The testing protocol for the gloves, five optimal formulations for preparing gloves with a high strength-comfort index, and various comparative examples, are shown below:

### Testing

The following tensile properties were measured using a tensile testing machine fitted with a non-contact extensometer: tensile stress at 25% elongation, T₂₅, tensile stress at 50% elongation, T₅₀, tensile stress at 100% elongation, T₁₀₀, tensile strength, and strain at break. Sample thickness was measured using a handheld micrometer. All tensile properties were measured following ASTM D 412, herein incorporated by reference in its entirety, except a handheld digital micrometer was used for determining the sample thickness. Die C was used to cut the tensile specimens for Comparative Examples 1-12. Die D was used to cut the tensile specimens for Comparative Examples 13-29 and Examples 1-5. SCI₂₅, SCI₅₀, and SCI₁₀₀ were calculated using the results from the tensile testing. Force at break was calculated using the results from the tensile testing for Comparative Examples 1-12 and measured following EN 455-2, herein incorporated by reference in its entirety, for Examples 1-5 and Comparative Examples 13-29.

As will be appreciated by those skilled in the art, the results may vary according to the die used to cut the tensile specimens. The scope of the present invention is believed to incorporate the range potential of dies, and as further appreciated in the ASTM and EN methods herein described.

### Example 1

A compound was prepared from 100 phr of a commercially available carboxylated nitrile latex, enough deionized water to reduce the compound non-volatile content to 20%, 0.5 phr zinc dibutyl dithiocarbamate, 1.0 phr sulfur, 0.85 phr zinc oxide, 1.5 phr titanium dioxide, and ammonia to give a final compound pH of 9.1. The compound was kept under mild agitation for approximately 24 hours before dipping.

Hand formers manufactured by Shinko (Code No. 021, ambidexterous, unglazed smooth surface—length 400mm) were prepared by rinsing with hot water. The glove formers were heated to 70° C. and dipped into a water-based coagulant mixture (ambient temperature, 30% calcium nitrate, 0.01 phr Tergitol Minfoam 1X) at an entry speed of 21.17 mm/s and an exit speed of 25.4 mm/s. The coagulant dipped formers were then dried in a 7020 C. oven for 1 minute followed immediately by dipping into the compound formulation described above (at ambient temperature) with an entry speed of 21.1 7mm/s, a 3 s dwell time, and an exit speed of 25.4 mm/s. The formers, now coated in a wet coagulated film, were then leached in a 35° C. water bath for 4 minutes. The leached formers were then placed in an oven at 70° C. for 30 minutes followed by a second oven at 132° C. for 15 minutes to dry and cure the films. The cured films were then powdered and removed from the formers to yield nitrile gloves. The tensile properties of these nitrile gloves were then measured.

### Example 2

A compound was prepared from 100 phr of a commercially available carboxylated nitrile latex, enough deionized water to reduce the compound non-volatile content to 20%, 0.5 phr zinc dibutyl dithiocarbamate, 1.0 phr sulfur, 0.75 phr zinc oxide, 1.5 phr titanium dioxide, and ammonia to give a final compound pH of 9.1. The compound was kept under mild agitation for approximately 24 hours before dipping.

Hand formers manufactured by Shinko (Code No. 021, ambidexterous, unglazed smooth surface—length 400mm) were prepared by rinsing with hot water. The glove formers were heated to 70° C. and dipped into a water-based coagulant mixture (ambient temperature, 30% calcium nitrate, 0.01 phr Tergitol Minfoam 1X) at an entry speed of 21.17 mm/s and an exit speed of 25.4 mm/s. The coagulant dipped formers were then dried in a 70° C. oven for 1 minute followed immediately by dipping into the compound formulation described above (at ambient temperature) with an entry speed of 21.17 mm/s and an exit speed of 25.4 mm/s. The formers, now coated in a wet coagulated film, were then leached in a 35° C. water bath for 4 minutes. The leached formers were then placed in an oven at 70° C. for 30 minutes followed by a second oven at 132° C. for 15 minutes to dry and cure the films. The cured films were then powdered and removed from the formers to yield nitrile gloves. The tensile properties of these nitrile gloves were then measured.

### Example 3

A compound was prepared from 100 phr of a commercially available carboxylated nitrile latex, enough deionized water to reduce the compound non-volatile content to 20%, 0.5 phr zinc dibutyl dithiocarbamate, 1.0 phr sulfur, 0.85 phr zinc oxide, 3.0 phr titanium dioxide, and ammonia to give a final compound pH of 8.9. The compound was kept under mild agitation for approximately 24 hours before dipping.

Hand formers manufactured by Shinko (Code No. 021, ambidexterous, unglazed smooth surface—length 400 mm) were prepared by rinsing with hot water. The glove formers were heated to 120° C. and dipped into a water-based coagulant mixture (ambient temperature, 30% calcium nitrate, 0.04 phr Tergitol Minfoam 1 X). The former was accelerated over 0.5 s to an entry speed of 21 mm/s. It had a dwell time in the coagulant mixture of 0.1 seconds, and then was accelerated over 0.5 s to an exit speed of 5 mm/sec. The coagulant dipped formers were then dried in a 120° C. oven for 30 seconds followed immediately by dipping into the compound formulation described above (at ambient temperature). To dip in the compound formulation the former was accelerated over 6 s to an entry speed of 21 mm/s. Once the finger and thumb crotches of the former had been immersed, the former was immediately accelerated over 0.5 s to 100 mm/s. It had a dwell time of 8 seconds and then was accelerated over 0.5 s to an exit speed of 21 mm/s. The formers, now coated in a wet coagulated film, were then leached in a 35° C. water bath for 4 minutes. The leached formers were then placed in an oven at 70° C. for 30 minutes followed by a second oven at 132° C. for 15 minutes to dry and cure the films. The cured films were then powdered and removed from the formers to yield nitrile gloves. The tensile properties of these nitrile gloves were then measured.

### Example 4

A compound was prepared from 100 phr of a commercially available carboxylated nitrile latex, enough deionized water to reduce the compound non-volatile content to 20%, 0.5 phr zinc dibutyl dithiocarbamate, 1.0 phr sulfur, 0.85 phr zinc oxide, 3.0 phr titanium dioxide, and ammonia to give a final compound pH of 8.9. The compound was kept under mild agitation for approximately 24 hours before dipping.

Hand formers manufactured by Shinko (Code No. 021, ambidexterous, unglazed smooth surface—length 400 mm) were prepared by rinsing with hot water. The glove formers were heated to 120° C. and dipped into a water-based coagulant mixture (ambient temperature, 30% calcium nitrate, 0.04 phr Tergitol Minfoam 1 X). The former was accelerated over 0.5 s to an entry speed of 21 mm/s. It had a dwell time in the coagulant mixture of 0.1 seconds, and then was accelerated over 0.5 s to an exit speed of 5 mm/sec. The coagulant dipped formers were then dried in a 120° C. oven for 30 seconds followed immediately by dipping into the compound formulation described above (at ambient temperature). To dip in the compound formulation the former was accelerated over 6 s to an entry speed of 21 mm/s. Once the finger and thumb crotches of the former had been immersed, the former was immediately accelerated over 0.5 s to 100 mm/s. It had a dwell time of 8 seconds and then was accelerated over 0.5 s to an exit speed of 21 mm/s. The formers, now coated in a wet coagulated film, were then leached in a 35° C. water bath for 4 minutes. The leached formers were then placed in an oven at 70° C. for 30 minutes followed by a second oven at 132° C. for 15 minutes to dry and cure the films. The cured films were then powdered and removed from the formers to yield nitrile gloves. The gloves were then chlorinated in a 1200 ppm chlorine solution for 30 seconds, rinsed in a 35° C. water bath for 1 minute, and dried in 70° C. oven for 20 minutes. The tensile properties of these nitrile gloves were then measured.

### Example 5

A compound was prepared from 100 phr of a commercially available carboxylated nitrile latex, enough deionized water to reduce the compound non-volatile content to 20%, 0.5 phr zinc dibutyl dithiocarbamate, 1.0 phr sulfur, 0.85 phr zinc oxide, 3.0 phr titanium dioxide, and ammonia to give a final compound pH of 8.9. The compound was kept under mild agitation for approximately 24 hours before dipping.

Hand formers manufactured by Shinko (Code No. 021, ambidexterous, unglazed smooth surface—length 400 mm) were prepared by rinsing with hot water. The glove formers were heated to 120° C. and dipped into a water-based coagulant mixture (ambient temperature, 30% calcium nitrate, 0.04 phr Tergitol Minfoam 1 X). The former was accelerated over 0.5 s to an entry speed of 21 mm/s. It had a dwell time in the coagulant mixture of 0.1 seconds, and then was accelerated over 0.5 s to an exit speed of 5 mm/sec. The coagulant dipped formers were then dried in a 120° C. oven for 30 seconds followed immediately by dipping into the compound formulation described above (at ambient temperature). To dip in the compound formulation the former was accelerated over 6 s to an entry speed of 21 mm/s. Once the finger and thumb crotches of the former had been immersed, the former was immediately accelerated over 0.5 s to 100 mm/s. It had a dwell time of 8 seconds and then was accelerated over 0.5 s to an exit speed of 21 mm/s. The formers, now coated in a wet coagulated film, were then leached in a 35° C. water bath for 4 minutes. The leached formers were then placed in an oven at 70° C. for 30 minutes followed by a second oven at 132° C. for 15 minutes to dry and cure the films. The cured films were then powdered and removed from the formers to yield nitrile gloves. The gloves were then chlorinated in a 1200 ppm chlorine solution for 1 minute, rinsed in a 35° C. water bath for 1 minute, and dried in 70° C. oven for 20 minutes. The tensile properties of these nitrile gloves were then measured.

### Comparative Example 1

The tensile properties of samples of a commercial natural rubber latex surgical glove type were measured.

### Comparative Example 2

The tensile properties of samples of a commercial thin vinyl glove type were measured.

### Comparative Example 3

The tensile properties of samples of a commercial thin vinyl glove type different from Comparative Example 2 were measured.

### Comparative Example 4

The tensile properties of samples of a commercial polyurethane glove type were measured.

### Comparative Example 5

The tensile properties of samples of a commercial thermoplastic elastomer surgical glove type were measured.

### Comparative Example 6

The tensile properties of samples of a commercial polychloroprene surgical glove type were measured.

### Comparative Example 7

The tensile properties of samples of a commercial thin natural rubber latex glove type were measured.

### Comparative Example 8

The tensile properties of samples of a commercial nitrile (carboxylated butadiene-acrylonitrile copolymer) glove type were measured.

### Comparative Example 9

The tensile properties of samples of a commercial nitrile glove type different from Comparative Example 8 were measured.

### Comparative Example 10

The tensile properties of samples of a commercial nitrile glove type different from Comparative Examples 8 and 9 were measured.

### Comparative Example 11

The tensile properties of samples of a commercial nitrile glove type different from Comparative Examples 8, 9, and 10 were measured.

### Comparative Example 12

The tensile properties of samples of a commercial nitrile glove type different from Comparative Examples 8, 9, 10, and 11 were measured.

### Comparative Example 13

The tensile properties of samples of a commercial nitrile glove type different from Comparative Examples 8, 9, 10, 11, and 12 were measured.

### Comparative Example 14

The tensile properties of samples of a commercial powder-free polychloroprene examination glove type were measured.

### Comparative Example 15

The tensile properties of samples of a commercial polychloroprene surgical glove type different from Comparative Example 6 were measured.

### Comparative Example 16

The tensile properties of samples of a commercial synthetic polyisoprene glove type were measured.

### Comparative Example 17

The tensile properties of samples of a commercial vinyl glove type different from Comparative Examples 2 and 3 were measured.

### Comparative Example 18

The tensile properties of samples of a commercial vinyl glove type different from Comparative Examples 2, 3 and 17 were measured.

### Comparative Example 19

The tensile properties of samples of a commercial nitrile glove type different from Comparative Examples 8, 9, 10, 11, 12, and 13 were measured.

### Comparative Example 20

The tensile properties of samples of a commercial nitrile glove type different from Comparative Examples 8, 9, 10, 11, 12, 13, and 19 were measured.

### Comparative Example 21

The tensile properties of samples of a commercial nitrile glove type different from Comparative Examples 8, 9, 10, 11, 12, 13, 19, and 20 were measured.

### Comparative Example 22

The tensile properties of samples of a different lot of the same brand of commercial nitrile glove as Comparative Example 13 were measured.

### Comparative Example 23

The tensile properties of samples of a different lot of the same brand of commercial nitrile glove as Comparative Example 9 were measured.

### Comparative Example 24

The tensile properties of samples of a commercial nitrile glove type different from Comparative Examples 8, 9, 10, 11, 12, 13, 19, 20, 21, 22, and 23 were measured.

### Comparative Example 25

The tensile properties of samples of a commercial nitrile glove type different from Comparative Examples 8, 9, 10, 11, 12, 13, 19, 20, 21, 22, 23, and 24 were measured.

### Comparative Example 26

The tensile properties of samples of a commercial nitrile glove type different from Comparative Examples 8, 9,10,11, 12, 13, 19, 20, 21, 22, 23, 24, and 25 were measured.

### Comparative Example 27

The tensile properties of samples of a commercial natural rubber latex surgical glove type different from Comparative Example 1 were measured.

### Comparative Example 28

The tensile properties of samples of a commercial thin natural rubber latex glove type different from Comparative Example 7 were measured.

### Comparative Example 29

The tensile properties of samples of a commercial thin natural rubber latex glove type different from Comparative Examples 7 and 28 were measured.

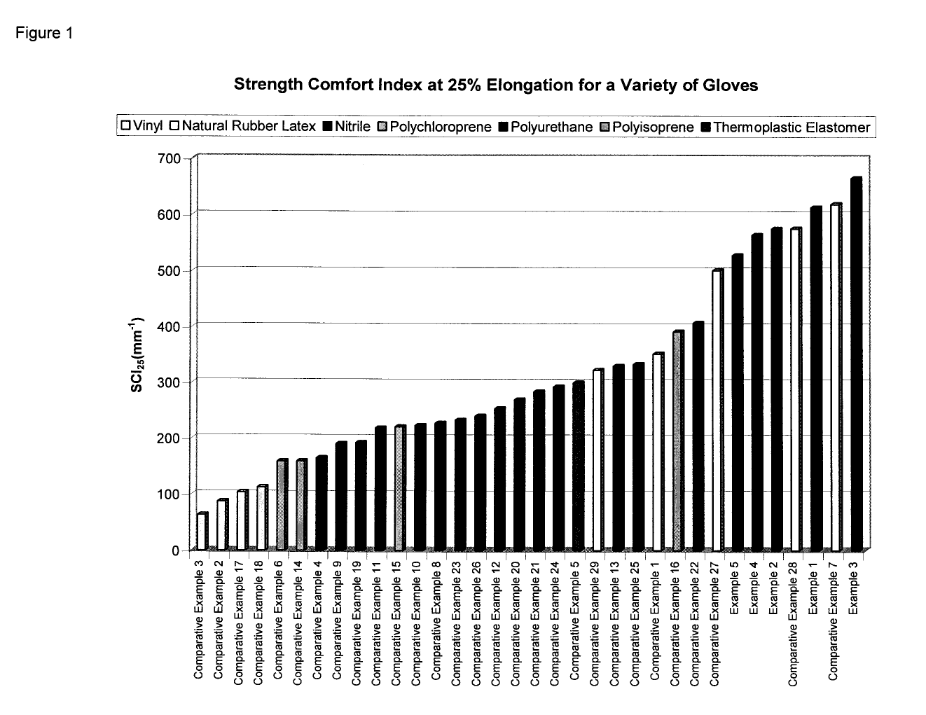

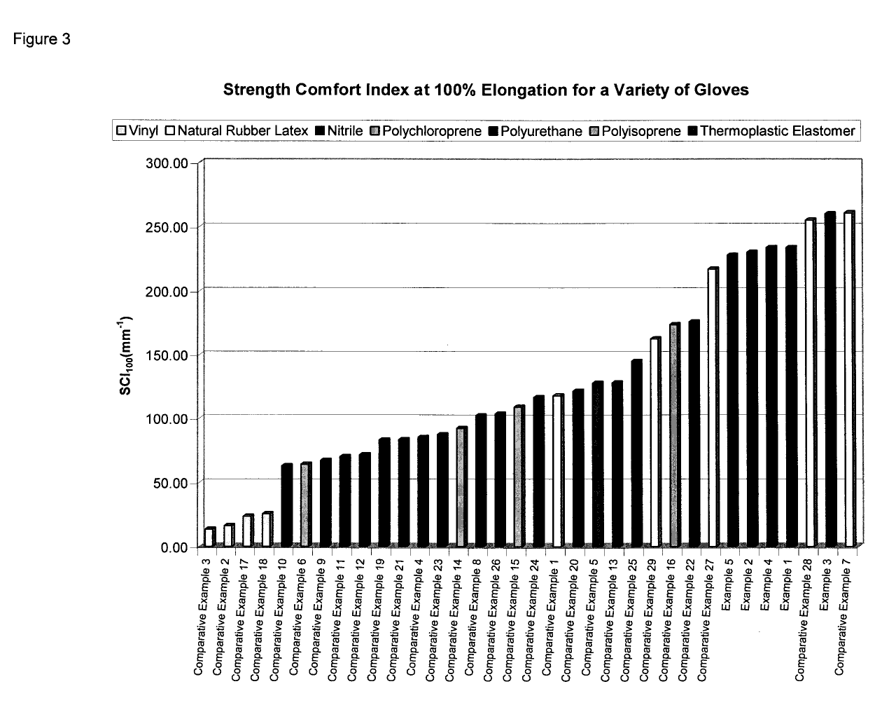

Table 1 shows the tensile data and calculated numbers for all of the Examples and Comparative Examples. FIGS. 1-3 plot SCI₂₅, SCI₅₀, and SCI₁₀₀ for these examples. The SCI₂₅ and SCI₅₀ values show that the novel performance observed from the five optimal nitrile formulations (Examples 1-5) is not merely a result of arbitrarily choosing 100% elongation as the basis for the strength comfort index. That is, the distinct performance is also seen when other low elongations are used as the basis of the strength comfort index.

TABLE 1

| | | | | | | | | Force | | | |
|---|---|---|---|---|---|---|---|---|---|---|---|
| | | | | | Max. | | | at | | | |
| | | T₂₅ | T₅₀ | T₁₀₀ | Stress | Strain at | Thickness | Break | SCI₂₅ | SCI₅₀ | SCI₁₀₀ |
| | Glove Type | (MPa) | (MPa) | (MPa) | (MPa) | Break (%) | (mm) | (N) | (mm⁻¹) | (mm⁻¹) | (mm⁻¹) |
| Comparative | Natural Rubber | 0.28 | 0.44 | 0.82 | 24.44 | 734 | 0.25 | 18.44 | 351.49 | 219.77 | 117.88 |
| Example 1 | Latex | | | | | | | | | | |
| Comparative | Vinyl | 1.03 | 2.10 | 5.52 | 11.20 | 270 | 0.12 | 4.18 | 87.07 | 42.77 | 16.31 |
| Example 2 | | | | | | | | | | | |
| Comparative | Vinyl | 1.45 | 2.84 | 6.72 | 13.28 | 263 | 0.14 | 5.77 | 63.13 | 32.34 | 13.65 |
| Example 3 | | | | | | | | | | | |
| Comparative | Polyurethane | 3.26 | 4.53 | 6.28 | 54.29 | 585 | 0.10 | 16.55 | 164.15 | 118.05 | 85.14 |
| Example 4 | | | | | | | | | | | |
| Comparative | Thermoplastic | 0.26 | 0.39 | 0.61 | 17.90 | 804 | 0.23 | 12.28 | 299.31 | 201.57 | 127.91 |
| Example 5 | Elastomer | | | | | | | | | | |
| Comparative | Polychloroprene | 0.51 | 0.78 | 1.27 | 14.28 | 626 | 0.18 | 7.51 | 158.63 | 104.98 | 64.07 |
| Example 6 | | | | | | | | | | | |
| Comparative | Natural Rubber | 0.32 | 0.45 | 0.75 | 25.96 | 731 | 0.13 | 10.29 | 618.63 | 432.38 | 260.81 |
| Example 7 | Latex | | | | | | | | | | |
| Comparative | Nitrile | 0.66 | 0.97 | 1.46 | 17.07 | 563 | 0.11 | 5.85 | 226.53 | 154.38 | 102.20 |
| Example 8 | | | | | | | | | | | |
| Comparative | Nitrile | 0.77 | 1.15 | 2.17 | 15.86 | 544 | 0.11 | 5.20 | 189.85 | 126.58 | 67.05 |
| Example 9 | | | | | | | | | | | |
| Comparative | Nitrile | 0.96 | 1.54 | 3.40 | 17.58 | 394 | 0.08 | 4.34 | 222.51 | 138.71 | 62.83 |
| Example 10 | | | | | | | | | | | |
| Comparative | Nitrile | 0.90 | 1.41 | 2.80 | 15.20 | 451 | 0.08 | 3.53 | 217.92 | 139.10 | 70.05 |
| Example 11 | | | | | | | | | | | |
| Comparative | Nitrile | 0.99 | 1.59 | 3.50 | 18.17 | 394 | 0.07 | 3.95 | 253.15 | 157.62 | 71.61 |
| Example 12 | | | | | | | | | | | |
| Comparative | Nitrile | 1.40 | 2.13 | 3.60 | 31.13 | 468 | 0.07 | 6.10 | 329.42 | 216.52 | 128.11 |
| Example 13 | | | | | | | | | | | |
| Example 1 | Nitrile | 1.03 | 1.57 | 2.70 | 49.25 | 515 | 0.08 | 11.62 | 613.02 | 402.17 | 233.86 |
| Example 2 | Nitrile | 0.92 | 1.36 | 2.30 | 39.69 | 502 | 0.08 | 9.47 | 575.22 | 389.12 | 230.09 |
| Comparative | Polychloroprene | 1.14 | 1.52 | 1.96 | 22.98 | 705 | 0.13 | 8.47 | 158.72 | 119.04 | 92.32 |
| Example 14 | | | | | | | | | | | |
| Comparative | Polychloroprene | 0.59 | 0.85 | 1.19 | 23.36 | 874 | 0.18 | 12.28 | 219.96 | 152.68 | 109.06 |
| Example 15 | | | | | | | | | | | |
| Comparative | Polyisoprene | 0.32 | 0.47 | 0.72 | 28.28 | 1040 | 0.23 | 19.18 | 391.04 | 266.24 | 173.80 |
| Example 16 | | | | | | | | | | | |
| Comparative | Vinyl | 1.25 | 2.45 | 5.51 | 13.99 | 355 | 0.11 | 4.50 | 103.63 | 52.87 | 23.51 |
| Example 17 | | | | | | | | | | | |
| Comparative | Vinyl | 1.22 | 2.38 | 5.38 | 14.67 | 391 | 0.11 | 4.64 | 112.38 | 57.61 | 25.48 |
| Example 18 | | | | | | | | | | | |
| Comparative | Nitrile | 0.66 | 0.98 | 1.52 | 17.18 | 613 | 0.14 | 7.01 | 191.40 | 128.90 | 83.11 |
| Example 19 | | | | | | | | | | | |
| Comparative | Nitrile | 0.71 | 1.01 | 1.57 | 18.14 | 526 | 0.10 | 4.72 | 268.94 | 189.06 | 121.62 |
| Example 20 | | | | | | | | | | | |
| Comparative | Nitrile | 1.30 | 2.12 | 4.42 | 40.14 | 448 | 0.11 | 12.97 | 283.27 | 173.71 | 83.32 |
| Example 21 | | | | | | | | | | | |
| Comparative | Nitrile | 1.22 | 1.81 | 2.82 | 39.19 | 602 | 0.08 | 8.92 | 406.62 | 274.08 | 175.91 |
| Example 22 | | | | | | | | | | | |
| Comparative | Nitrile | 0.96 | 1.48 | 2.55 | 26.06 | 587 | 0.12 | 9.24 | 232.02 | 150.50 | 87.35 |
| Example 23 | | | | | | | | | | | |
| Comparative | Nitrile | 0.97 | 1.47 | 2.43 | 24.93 | 438 | 0.09 | 6.36 | 292.06 | 192.72 | 116.58 |
| Example 24 | | | | | | | | | | | |
| Comparative | Nitrile | 0.78 | 1.16 | 1.79 | 33.21 | 701 | 0.13 | 12.51 | 332.63 | 223.67 | 144.95 |
| Example 25 | | | | | | | | | | | |
| Comparative | Nitrile | 0.91 | 1.35 | 2.10 | 23.96 | 603 | 0.11 | 7.99 | 239.36 | 161.35 | 103.72 |
| Example 26 | | | | | | | | | | | |
| Example 3 | Nitrile | 1.06 | 1.58 | 2.71 | 50.74 | 512 | 0.07 | 10.81 | 664.83 | 446.03 | 260.05 |
| Example 4 | Nitrile | 1.29 | 1.94 | 3.11 | 50.90 | 532 | 0.07 | 10.72 | 563.68 | 374.82 | 233.81 |
| Example 5 | Nitrile | 1.37 | 2.06 | 3.17 | 49.49 | 524 | 0.07 | 10.14 | 527.36 | 350.72 | 227.91 |
| Comparative | Natural Rubber | 0.36 | 0.52 | 0.83 | 31.00 | 769 | 0.17 | 15.77 | 500.65 | 346.60 | 217.15 |
| Example 27 | Latex | | | | | | | | | | |
| Comparative | Natural Rubber | 0.43 | 0.62 | 0.97 | 32.16 | 804 | 0.13 | 12.64 | 575.31 | 399.01 | 255.04 |
| Example 28 | Latex | | | | | | | | | | |
| Comparative | Natural Rubber | 0.55 | 0.75 | 1.09 | 22.85 | 697 | 0.13 | 8.85 | 322.06 | 236.18 | 162.51 |
| Example 29 | Latex | | | | | | | | | | |

As shown in the Table and in FIGS. 1-3, Examples 1-5 showed the closest matches to the thin natural rubber latex glove in for the strength-comfort index calculated at each elongation.

As noted above, the specific results observed may vary according to and depending on the die used to cut the specimen and expected variations or differences in the results are contemplated in accordance with practice of the present invention.

### ASTM D-412 and EN 455-2

Each of ASTM D-412 and EN 455-2 are incorporated herein by reference. In addition, the text portions of each are recreated here:

### ASTM International Designation: D 412-98a (Reapproved 2002)

### Standard Test Methods for Vulcanized Rubber and Thermoplastic Elastomers—Tension

### 1. Scope

1.1 These test methods cover procedures used to evaluate the tensile (tension) properties of vulcanized thermoset rubbers and thermoplastic elastomers. These methods are not applicable to ebonite and similar hard, low elongation materials. The methods appear as follows:
Test Method A-Dumbbell and Straight Section Specimens
Test Method B-cut Ring Specimens
   NOTE—These two different methods do not produce identical results.

1.2 The values stated in either SI or non-SI units shall be regarded separately as normative for this standard. The values in each system may not be exact equivalents; therefore each system must be used independently, without combining values.

1.3 This standard does not purport to address all of the safety concerns, if any, associated with its use. It is the responsibility of the user of this standard to establish appropriate safety and health practices and determine the applicability of regulatory limitations prior to use.

### 2. Referenced Documents

2.1 ASTM Standards:
D 1349 Practice for Rubber-Standard Temperatures for Testing
D 1566 Terminology Relating to Rubber
D 3182 Practice for Rubber-Materials, Equipment and Procedures for Mixing Standard Compounds and Preparing Standard Vulcanized Sheets
D 3183 Practice for Rubber-Preparation of Pieces for Test Purposes from Products
D 3767 Practice for Rubber-Measurement of Dimensions
D 4483 Practice for Determining Precision for Test Method Standards in the Rubber and Carbon Black Industries
E 4 Practices for Force Verification of Testing Machines

2.2 ASTM Adjunct:
Cut Ring Specimens, Method B (D 412)

2.3 ISO Standards:
ISO 37 Rubber, Vulcanized and Thermoplastic Determination of Tensile Stress-Strain Properties

### 3. Terminology

3.1 Definitions:

3.1.1 tensile set—the extension remaining after a specimen has been stretched and allowed to retract in a specified manner, expressed as a percentage of the original length. (D 1566)

3.1.2 tensile set-after-break—the tensile set measured by fitting the two broken dumbbell pieces together at the point of rupture.

3.1.3 tensile strength—the maximum tensile stress applied in stretching a specimen to rupture. (D 1566)

3.1.4 tensile stress—a stress applied to stretch a test piece (specimen). (D 1566)

3.1.5 tensile stress at-given-elongation—the stress required to stretch the uniform cross section of a test specimen to a given elongation. (D 1566)

3.1.6 thermoplastic elastomers—a diverse family of rubber-like materials that unlike conventional vulcanized rubbers can be processed and recycled like thermoplastic materials.

3.1.7 ultimate elongation—the elongation at which rupture occurs in the application of continued tensile stress.

3.1.8 yield point—that point on the stress-strain curve, short of ultimate failure, where the rate of stress with respect to strain, goes through a zero value and may become negative. (D 1566)

3.1.9 yield strain—the level of strain at the yield point. (D 1566)

3.1.10 yield stress—the level of stress at the yield point. (D 1566)

### 4. Summary of Test Method

4.1 The determination of tensile properties starts with test pieces taken from the sample material and includes the preparation of the specimens and testing of the specimens. Specimens may be in the shape of dumbbells, rings or straight pieces of uniform cross-sectional area.

4.2 Measurements for tensile stress, tensile stress at a given elongation, tensile strength, yield point, and ultimate elongation are made on specimens that have not been prestressed. Tensile stress, yield point, and tensile strength are based on the original cross-sectional area of a uniform cross-section of the specimen.

4.3 Measurement of tensile set is made after a previously unstressed specimen has been extended and allowed to retract by a prescribed procedure. Measurement of “set after break” is also described.

### 5. Significance and Use

5.1 All materials and products covered by these test methods must withstand tensile forces for adequate performance in certain applications. These test methods allow for the measurement of such tensile properties. However, tensile properties alone may not directly relate to the total end use performance of the product because of the wide range of potential performance requirements in actual use.

5.2 Tensile properties depend both on the material and the conditions of test (extension rate, temperature, humidity, specimen geometry, pretest conditioning, etc.); therefore materials should be compared only when tested under the same conditions.

5.3 Temperature and rate of extension may have substantial effects on tensile properties and therefore should be controlled. These effects will vary depending on the type of material being tested.

5.4 Tensile set represents residual deformation which is partly permanent and partly recoverable after stretching and retraction. For this reason, the periods of extension and recovery (and other conditions of test) must be controlled to obtain comparable results.

### 6. Apparatus

6.1 Testing Machine—Tension tests shall be made on a power driven machine equipped to produce a uniform rate of grip separation of 500±50 mm/min (20±2 in./min) for a distance of at least 750 mm (30 in.) (A rate of elongation of 1000±100 mm/mn (40±4 in./min) may be used and notation of the speed made in the report. In case of dispute, the test shall be repeated and the rate of elongation shall be at 500±50 mm/min 20±2 in./min).) The testing machine shall have both a suitable dynamometer and an indicating or recording system for measuring the applied force within ±2%. If the capacity range cannot be changed for a test (as in the case of pendulum dynamometers) the applied force at break shall be measured within ±2% of the full scale value, and the smallest tensile force measured shall be accurate to within 10%. If the dynamometer is of the compensating type for measuring tensile stress directly, means shall be provided to adjust for the cross-sectional area of the specimen. The response of the recorder shall be sufficiently rapid that the applied force is measured with the requisite accuracy during the extension of the specimen to rupture. If the testing machine is not equipped with a recorder, a device shall be provided that indicates, after rupture, the maximum force applied during extension. Testing machine systems shall be capable of measuring elongation of the test specimen in minimum increments of 10%.

6.2 Test Chamber for Elevated and Low Temperatures—The test chamber shall conform with the following requirements:

6.2.1 Air shall be circulated through the chamber at a velocity of 1 to 2 m/s (3.3 to 6.6 ft/s) at the location of the grips or spindles and specimens maintained within 2° C. (3.6° F.) of the specified temperature.

6.2.2 A calibrated sensing device shall be located near the grips or spindles for measuring the actual temperature.

6.2.3 The chamber shall be vented to an exhaust system or to the outside atmosphere to remove fumes liberated at high temperatures.

6.2.4 Provisions shall be made for suspending specimens vertically near the grips or spindles for conditioning prior to test. The specimens shall not touch each other or the sides of the chamber except for momentary contact when agitated by the circulating air.

6.2.5 Fast acting grips suitable for manipulation at high or low temperatures may be provided to permit placing dumbbells or straight specimens in the grips in the shortest time possible to minimize any change in temperature of the chamber.

6.2.6 The dynamometer shall be suitable for use at the temperature of test or it shall be thermally insulated from the chamber.

6.2.7 Provision shall be made for measuring the elongation of specimens in the chamber. If a scale is used to measure the extension between the bench-marks, the scale shall be located parallel and close to the grip path during the specimen extension and shall be controlled from outside the chamber.

6.3 Dial Micrometer—The dial micrometer shall conform to the requirements of Practice D 3767 (Method A). For ring specimens, see 14.10 of these test methods.

6.4 Apparatus for Tensile Set Test—The testing machine described in 6.1 or an apparatus similar to that shown in FIG. 1 may be used. A stop watch or other suitable timing device measuring in minute intervals for at least 30 min, shall be provided. A scale or other device shall be provided for measuring tensile set to within 1%.

### 7. Selection of Test Specimens

7.1 Consider the following information in making selections:

7.1.1 Since anisotropy or grain directionality due to flow introduced during processing and preparation may have an influence on tensile properties, dumbbell or straight specimens should be cut so the lengthwise direction of the specimen is parallel to the grain direction when this direction is known. Ring specimens normally give an average of with and across the grain properties.

7.1.2 Unless otherwise noted, thermoplastic rubber or thermoplastic elastomer specimens, or both, are to be cut from injection molded sheets or plaques with a thickness of 3.0±0.3 mm. Specimens of other thickness will not necessarily give comparable results. Specimens are to be tested in directions both parallel and perpendicular to the direction of flow in the mold. Sheet or plaque dimensions must be sufficient to do this.

7.1.3 Ring specimens enable elongations to be measured by grip separation, but the elongation across the radial width of the ring specimens is not uniform. To minimize this effect the width of the ring specimens must be small compared to the diameter.

7.1.4 Straight specimens tend to break in the grips if normal extension-to-break testing is conducted and should be used only when it is not feasible to prepare another type of specimen. For obtaining non-rupture stress-strain or material modulus properties, straight specimens are quite useful.

7.1.5 The size of specimen type used will be determined by the material, test equipment and the sample or piece available for test. A longer specimen may be used for rubbers having low ultimate elongation to improve precision of elongation measurement.

### 8. Calibration of the Testing Machine

8.1 Calibrate the testing machine in accordance with Procedure A of Practice E 4. If the dynamometer is of the strain-gage type, calibrate the tester at one or more forces in addition to the requirements in Sections 7 and 18 of Practice E 4. Testers having pendulum dynamometers may be calibrated as follows:

8.1.1 Place one end of a dumbbell specimen in the upper grip of the testing machine.

8.1.2 Remove the lower grip from the machine and attach it, by means of the gripping mechanism to the dumbbell specimen in the upper grip.

8.1.3 Attach a hook to the lower end of the lower specimen grip mechanism.

8.1.4 Suspend a known mass from the hook of the lower specimen grip mechanism in such a way as to permit the mass assembly to temporarily rest on the lower testing machine grip framework or holder. (It is advisable to provide a means for preventing the known mass from falling to the floor in case the dumbbell should break.)

8.1.5. Start the grip separation motor or mechanism, as in normal testing, and allow it to run until the mass is freely suspended by the specimen in the upper grip.

8.1.6 If the dial or scale does not indicate the force applied (or its equivalent in stress for a compensating type tester) within specified tolerance, thoroughly inspect the testing machine for malfunction (for example, excess friction in bearings and other moving parts). Ensure that the mass of the lower grip mechanism and the hook are included as part of the known mass.

8.1.7 After machine friction or other malfunction has been removed, recalibrate the testing machine at a minimum of three points using known masses to produce forces of approximately 10, 20 and 50% of capacity. If pawls or rachets are used during routine testing, use them for calibration. Check for friction in the head by calibrating with the pawls up.

8.2 A rapid approximate calibration of the testing machine may be obtained by using a spring calibration device.

### 9. Test Temperature

9.1 Unless otherwise specified, the standard temperature for testing shall be

23±2° C. (73.4±3.6° F.). Specimens shall be conditioned for at least 3 h when the test temperature is 23° C. (73.4° F.). If the material is affected by moisture, maintain the relative humidity at 50±5% and condition the specimens for at least 24 h prior to testing. When testing at any other temperature is required use one of the temperatures listed in Practice D 1349.

9.2 For testing at temperatures above 23° C. (73.4° F.) preheat specimens for 10±2 min for Method A and for 6±2 min for Method B. (NOTE—The condition of the die may be determined by investigating the rupture point on any series of broken (ruptured) specimens. Remove such specimens from the grips of the testing machine, stack the joined-together specimens on top of each other, and note if there is any tendency for tensile breaks to occur at the same position on each of the specimens. Rupture consistently at the same place indicates that the die may be dull, nicked, or bent at that location.) Place each specimen in the test chamber at intervals ahead of testing so that all specimens of a series will be in the chamber the same length of time. The preheat time at elevated temperatures must be limited to avoid additional vulcanization or thermal aging. (Warning—In addition to other precautions, suitable heat or cold resistant gloves should be worn for arm and hand protection when testing at other than 23° C. (73.4° F.). A mask for the face is very desirable for high temperature testing to prevent the inhalation of toxic fumes when the door of the chamber is open.)

9.3 For testing at temperatures below 23° C. (73.4° F.) condition the specimens at least 10 min prior to testing.

### Test Method A—Dumbbell and Straight Specimens

### 10. Apparatus

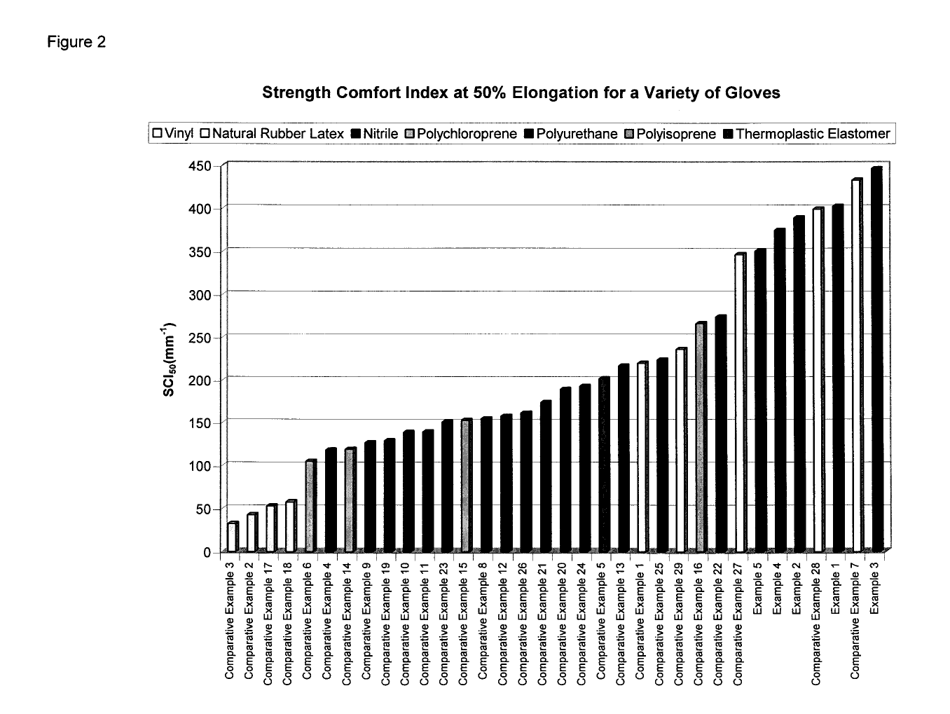

10.1 Die—The shape and dimensions of the die for preparing dumbbell specimens shall conform with those shown in FIG. 2. The inside faces in the reduced section shall be perpendicular to the plane formed by the cutting edges and polished for a distance of at least 5 mm (0.2 in.) from the cutting edge. The die shall at all times be sharp and free of nicks (see 9.2).

10.2 Bench Marker—The two marks placed on the specimen and used to measure elongation or strain are called “bench marks. The bench marker shall consist of a base plate containing two raised parallel projections. The surfaces of the raised projections (parallel to the plane of the base plate) are ground smooth in the same plane. The raised projection marking surfaces shall be between 0.05 and 0.08 mm (0.002 and 0.003 in.) wide and at least 15 mm (0.6 in.) long. The angles between the parallel marking surfaces and the sides of the projections shall be at least 75°. The distance between the centers of the two parallel projections or marking surfaces shall be within 1% of the required or target bench mark distance. A handle attached to the back or top of the bench marker base plate is normally a part of the bench marker.

NOTE—If a contact extensometer is used to measure elongation, bench marks are not necessary.

10.3 Ink Applicator—A flat unyielding surface (hardwood, metal, or plastic) shall be used to apply either ink or powder to the bench marker. The ink or powder shall adhere to the specimen, have no deteriorating effect on the specimen and be of contrasting color to that of the specimen.

10.4 Grips—The testing machine shall have two grips, one of which shall be connected to the dynamometer.

10.4.1 Grips for testing dumbbell specimens shall tighten automatically and exert a uniform pressure across the gripping surfaces, increasing as the tension increases in order to prevent slippage and to favor failure of the specimen in the straight reduced section. Constant pressure pneumatic type grips also are satisfactory. At the end of each grip a positioning device is recommended for inserting specimens to the same depth in the grip and for alignment with the direction of pull.

10.4.2 Grips for testing straight specimens shall be constant pressure pneumatic, wedged, or toggle type designed to transmit the applied gripping force over the entire width of the gripped specimen.

### 11. Specimens

11.1 Dumbbell Specimens—Whenever possible, the test specimens shall be injection molded or cut from a flat sheet not less than 1.3 mm (0.05 in.) nor more than 3.3 mm (0.13 in.) thick and of a size which will permit cutting a specimen by one of the standard methods (see Practice D 3182). Sheets may be prepared directly by processing or from finished articles by cutting and buffing. If obtained from a manufactured article, the specimen shall be free of surface roughness, fabric layers, etc. in accordance with the procedure described in Practice D 3183. All specimens shall be cut so that the lengthwise portion of the specimens is parallel to the grain unless otherwise specified. In the case of sheets prepared in accordance with Practice D 3182, the specimen shall be 2.0±0.2 mm (0.08±0.008 in.) thick died out in the direction of the grain. Use Die C (unless otherwise noted) to cut the specimens from the sheet with a single impact stroke (hand or machine) to ensure smooth cut surfaces.

FIG. 2 a (continued)
Dimensions of Standard Dumbbell Dies^{A} (Metric Units)

| Dimension | Units | Tolerance | Die A | Die B | Die C | Die D | Die E | Die F |
|---|---|---|---|---|---|---|---|---|
| A | Mm | ±1 | 25 | 25 | 25 | 16 | 16 | 16 |
| B | Mm | Max | 40 | 40 | 40 | 30 | 30 | 30 |
| C | Mm | Min | 140 | 140 | 115 | 100 | 125 | 125 |
| D | Mm | ±6^{B} | 32 | 32 | 32 | 32 | 32 | 32 |
| D-E | Mm | ±1 | 13 | 13 | 13 | 13 | 13 | 13 |
| F | Mm | ±2 | 38 | 38 | 19 | 19 | 38 | 38 |
| G | Mm | ±1 | 14 | 14 | 14 | 14 | 14 | 14 |
| H | Mm | ±2 | 25 | 25 | 25 | 16 | 16 | 16 |
| L | Mm | ±2 | 59 | 59 | 33 | 33 | 59 | 59 |
| W | Mm | ±0.05, | 12 | 6 | 6 | 3 | 3 | 6 |
| | | −0.00 | | | | | | |
| Z | Mm | ±1 | 13 | 13 | 13 | 13 | 13 | 13 |

^{A}Dies whose dimensions are expressed in metric units are not exactly the same as dies
whose dimensions are expressed in U.S. customary units. Dies dimensioned in metric
units are intended for use with apparatus calibrated in metric units.
^{B}For dies used in clicking machines it is preferable that this tolerance by ±0.05 mm

FIG. 2 b (continued)
Dimensions of Standard Dumbbell Dies^{A} (U.S. Customary Units)

| Dimension | Units | Tolerance | Die A | Die B | Die C | Die D | Die E | Die F |
|---|---|---|---|---|---|---|---|---|
| A | in. | ±0.04 | 1 | 1 | 1 | 0.62 | 0.62 | 0.62 |
| B | in. | Max | 1.6 | 1.6 | 1.6 | 1.2 | 1.2 | 1.2 |
| C | in. | Min | 5.5 | 5.5 | 4.5 | 4 | 5 | 5 |
| D | in. | ±0.25^{B} | 1.25 | 1.25 | 1.25 | 1.25 | 1.25 | 1.25 |
| D-E | in. | ±0.04 | 0.5 | 0.5 | 0.5 | 0.5 | 0.5 | 0.5 |
| F | in. | ±0.08 | 1.5 | 1.5 | 0.75 | 0.75 | 1.5 | 1.5 |
| G | in. | ±0.04 | 0.56 | 0.56 | 0.56 | 0.56 | 0.56 | 0.56 |
| H | in. | ±0.08 | 1 | 1 | 1 | 0.63 | 0.63 | 0.63 |
| L | in. | ±0.08 | 2.32 | 2.32 | 1.31 | 1.31 | 2.32 | 2.32 |
| W | in. | ±0.02, | 0.500 | 0.250 | 0.250 | 0.125 | 0.125 | 0.250 |
| | | −0.000 | | | | | | |
| Z | in. | ±0.04 | 0.5 | 0.5 | 0.5 | 0.5 | 0.5 | 0.5 |

^{A}Dies whose dimensions are expressed in metric units are not exactly the same as dies
whose dimensions are expressed in U.S. customary units.
^{B}For dies used in clicking machines it is preferable that this tolerance by ±0.02 in.

11.1.1 Marking Dumbbell Specimens—Dumbbell specimens shall be marked with the bench marker described in 10.2, with no tension on the specimens at the time of marking. Marks shall be placed on the reduced section, equidistant from its center and perpendicular to the longitudinal axis. The between bench mark distance shall be as follows: for Die C or Die D of FIG. 2, 25.00±0.25 mm (1.00±0.01 in); for any other Die of FIG. 2, 50.00±0.5 mm (2.00±0.02 in).

11.1.2 Measuring Thickness of Dumbbell Specimens—Three measurements shall be made for the thickness, one at the center and one at each end of the reduced section. The median of the three measurements shall be used as the thickness in calculating the cross sectional area. Specimens with a difference between the maximum and the minimum thickness exceeding 0.08 mm (0.003 in.), shall be discarded. The width of the specimen shall be taken as the distance between the cutting edges of the die in the restricted section.

11.2 Straight Specimens—Straight specimens may be prepared if it is not practical to cut either a dumbbell or a ring specimen as in the case of a narrow strip, small tubing or narrow electrical insulation material. These specimens shall be of sufficient length to permit their insertion in the grips used for the test. Bench marks shall be placed on the specimens as described for dumbbell specimens in 11.1.1. To determine the cross sectional area of straight specimens in the form of tubes, the mass, length, and density of the specimen may be required. The cross sectional area shall be calculated from these measurements as follows:

A=M/DL (1)

where:
A=cross-sectional area, cm²,
M=mass, g,
D=density, g/cm³, and
L=length, cm.
NOTE:—A in square inches=A (cm²)×0.155.

### 12. Procedure

12.1 Determination of Tensile Stress, Tensile Strength and Yield Point—Place the dumbbell or straight specimen in the grips of the testing machine, using care to adjust the specimen symmetrically to distribute tension uniformly over the cross section. This avoids complications that prevent the maximum strength of the material from being evaluated. Unless otherwise specified, the rate of grip separation shall be 500±50 mm/min (20±2 in./min) (For materials having a yield point (yield strain) under 20% elongation when tested at 500± mm/min (20±2 in./min), the rate of elongation shall be reduced to 50±5 mm/min (2.0±0.2 in./min). If the material still has a yield point (strain) under 20% elongation, the rate shall be reduced to 5±0.5 mm/min (0.2±0.002 in./min). The actual rate of separation shall be reported.) Start the machine and note the distance between the bench marks, taking care to avoid parallax. Record the force at the elongation(s) specified for the test and at the time of rupture. The elongation measurement is made preferably through the use of an extensometer, an autographic mechanism or a spark mechanism. At rupture, measure and record the elongation to the nearest 10%. See Section 13 for calculations.

12.2 Determination of Tensile Set—Place the specimen in the grips of the testing machine described in 6.1 and adjust symmetrically so as to distribute the tension uniformly over the cross section. Separate the grips at a rate of speed as uniformly as possible, that requires 15 s to reach the specified elongation. Hold the specimen at the specified elongation for 10 min, release quickly without allowing it to snap back and allow the specimen to rest for 10 min. At the end of the 10 min rest period, measure the distance between the bench marks to the nearest 1% of the original between bench mark distance. Use a stop watch for the timing operations. See Section 13 for calculations.

12.3 Determination of Set-After-Break—Ten minutes after a specimen is broken in a normal tensile strength test, carefully fit the two pieces together so that they are in good contact over the full area of the break. Measure the distance between the bench marks. See Section 13 for calculations.

### 13. Calculation

13.1 Calculate the tensile stress at any specified elongation as follows:

T₍ₓₓₓ₎−F₍ₓₓₓ₎^{/A} (2)

where:
T₍ₓₓₓ₎=tensile stress at (xxx) % elongation, MPa (1 bf/in.²)
F₍ₓₓₓ₎=force at specified elongation, MN or (1 bf), and
A=cross-sectional area of unstrained specimen, m² (in.²).

13.2 Calculate the yield stress as follows:

Y₍ₛₜᵣₑₛₛ₎=F_{(y)}/A (3)

where:
Y₍ₛₜᵣₑₛₛ₎=yield stress, that stress level where the yield point occurs, MPa (1bf/in.²),
F_{(y)}=magnitude of force at the yield point, MN (1 bf, and
A=cross-sectional area of unstrained specimen, m² (in.²).

13.3 Evaluate the yield strain as that strain or elongation magnitude, where the rate of change of stress with respect to strain, goes through a zero value.

13.4 Calculate the tensile strength as follows:

TS=F_{(BE)}/^{A} (4)

where:
TS=tensile strength, the stress at rupture, MPa (1 bf/in.²),
F_{(BE)}=the force magnitude at rupture, MN (1 bf, and
A=cross-sectional area of unstrained specimen, m² (in.²).

13.5 Calculate the elongation (at any degree of extension) as follows:

E=100[L−L₍ₒ₎]/L₍ₒ₎ (5)

where:
E=the elongation in percent (of original bench mark distance),
L=observed distance between bench marks on the extended specimen, and
L₍ₒ₎=original distance between bench marks (use same units for L and L₍ₒ₎).

13.6 The breaking or ultimate elongation is evaluated when L is equal to the distance between bench marks at the point of specimen rupture.

13.7 Calculate the tensile set, by using Eq 5, where L is equal to the distance between bench marks after the 10 min retraction period.

13.8 Test Result—A test result is the median of three individual test measurement values for any of the measured properties as described above, for routine testing. There are two exceptions to this and for these exceptions a total of five specimens (measurements) shall be tested and the test result reported as the median of five.

13.8.1 Exception 1—If one or two of the three measured values do not meet specified requirement values when testing for compliance with specifications.

13.8.2 Exception 2—If referee tests are being conducted.

### Test Method B—Cut Ring Specimens

### 14. Apparatus

14.1 Cutter—A typical ring cutter is used for cutting rings from flat sheets by mounting the upper shaft portion of the cutter in a rotating housing that can be lowered onto a sheet held by the rubber holding plate.

14.1.1 Blade Depth Gage—This gage consists of a cylindrical disk having a thickness of at least 0.5 mm (0.02 in.) greater than the thickness of the rubber to be cut and a diameter less than the inside diameter of the specimen used for adjusting the protrusion of the blades from the body of the cutter.

14.2 Rubber Holding Plate—The apparatus for holding the sheet during cutting shall have plane parallel upper and lower surfaces and shall be a rigid polymeric material (hard rubber, polyurethane, polymethylmethacrylate) with holes approximately 1.5 mm (0.06 in.) in diameter spaced 6 or 7 mm (0.24 or 0.32 in.) apart across the central region of the plate. All the holes shall connect to a central internal cavity which can be maintained at a reduced pressure for holding the sheet in place due to atmospheric pressure.

14.3 Source of Reduced Pressure—Any device such as a vacuum pump that can maintain an absolute pressure below 10 kPa (0.1 atm) in the holding place central cavity.

14.4 Soap Solution—A mild soap solution shall be used on the specimen sheet to lubricate the cutter blades.

14.5 Cutter Rotator—A precision drill press or other suitable machine capable of rotating the cutter at an angular speed of at least 30 rad/s (approximately 300 r/min) during cutting shall be used. The cutter rotator device shall be mounted on a horizontal base and have a vertical support orientation for the shaft that rotates the spindle and cutter. The run-out of the rotating spindle shall not exceed 0.01 mm (0.004 in.).

14.6 Indexing Table—A milling table or other device with typical x-y motions shall be provided for positioning the sheet and holder with respect to the spindle of the cutter rotating device.

14.7 Tensile Testing Machine—A machine as specified in 6.1 shall be provided.

14.8 Test Fixture—A test fixture shall be provided for testing the ring specimens. The testing machine shall be calibrated as outlined in Section 8.

14.9 Test Chamber—A chamber for testing at high and low temperatures shall be provided as specified in 6.2.

14.9.1 The fixtures specified in 14.8 are satisfactory for testing at other than room temperature. However at extreme temperatures, a suitable lubricant shall be used to lubricate the spindle bearings.

14.9.2 The dynamometer shall be suitable for use at the temperature of test or thermally insulated from the chamber.

14.10 Dial Micrometer—A dial micrometer shall be provided that conforms to the requirements of Practice D 3767.

14.10.1 The base of the micrometer used to measure the radial width shall consist of an upper cylindrical surface (with its axis oriented in a horizontal direction) at least 12 mm (0.5 in.) long and 15.5±0.5 mm (0.61±0.02 in.) in diameter. To accommodate small diameter rings that approach the 15.5 mm (0.61 in.) diameter of the base and to avoid any ring extension in placing the ring on the base, the bottom half of the cylindrical surface may be truncated at the cylinder centerline, that is, a half cylinder shape. This permits placing small rings on the upper cylindrical surface without interference fit problems. Curved feet on the end of the dial micrometer shaft to fit the curvature of the ring(s), may be used.

### 15. Ring Specimen

15.1 ASTM Cut Rings—Two types of cut ring specimens may be used. Unless otherwise specified, the Type 1 ring specimen shall be used.

15.1.1 Ring Dimensions:

| | |
|---|---|
| mm | in. |

Type 1

| | | |
|---|---|---|
| Circumference (inside) | 50.0 ± 0.01 | 2.0 ± 0.004 |
| Diameter (inside) | 15.92 ± 0.003 | 0.637 ± 0.001 |
| Radial width | 1.0 ± 0.01 | 0.040 ± 0.0004 |
| Thickness, minimum | 1.0 | 0.040 |
| maximum | 3.3 | 0.13 |

Type 2

| | | |
|---|---|---|
| Circumference mean | 100.0 ± 0.2 | 4.0 ± 0.0004 |
| Diameter (inside) | 29.8 ± 0.06 | 1.19 ± 0.0001 |
| Radial width | 2.0 ± 0.02 | 0.08 ± 0.0008 |
| Thickness, minimum | 1.0 | 0.04 |
| maximum | 3.3 | 0.13 |

15.2 ISO Cut Rings—The normal size and the small size ring specimens in ISO 37 have the following dimensions given in mm. See ISO 37 for specific testing procedures for these rings.

| | Normal | | Small | |
|---|---|---|---|---|
| Diameter, inside | 44.6 ± 0.2 | mm | 8.0 ± 0.1 | mm |
| Diameter, outside | 52.6 ± 0.2 | mm | 10.0 ± 0.1 | mm |
| Thickness | 4.0 ± 0.2 | mm | 1.0 ± 0.1 | mm |

15.3 Rings Cut from Tubing—The dimensions of the ring specimen(s) depend on the diameter and wall thickness of the tubing and should be specified in the product specification.

15.4 Preparation of Cut Ring Specimens—Place the blades in the slots of the cutter and adjust the blade depth using the blade depth gage. Place the cutter in the drill press and adjust the spindle or table so that the bottom of the blade holder is about 13 mm (0.5 in.) above the surface of the holding plate. Set the stop on the vertical travel of the spindle so that the tips of the cutting blades just penetrate the surface of the plate. Place the sheet on the holding plate and reduce the pressure in the cavity to 10 kPa (0.1 atm) or less. Lubricate the sheet with mild soap solution. Lower the cutter at a steady rate until it reaches the stop. Be sure that the blade holder does not contact the sheet. If necessary, readjust the blade depth. Return the spindle to its original position and repeat the operation on another sheet.

15.5 Preparation of Ring Specimens from Tubing—Place the tubing on a mandrel preferably slightly larger than the inner diameter of the tubing. Rotate the mandrel and tubing in a lathe. Cut ring specimens to the desired axial length by means of a knife or razor blade held in the tool post of the lathe. Lay thin wall tubing flat and cut ring specimens with a die or cutting mechanism having two parallel blades.

### 15.6 Ring Dimension Measurements:

15.6.1 Circumference—The inside circumference can be determined by a stepped cone or by “go-no go” gages. Do not use any stress in excess of that needed to overcome any ellipticity of the ring specimen. The mean circumference is obtained by adding to the value for the inside circumference, the product of the radial width and π (3.14).

15.6.2 Radial Width—The radial width is measured at three locations distributed around the circumference using the micrometer described in 14.10.

15.6.3 Thickness—For cut rings, the thickness of the disk cut from the inside of the ring is measured with a micrometer described in Practice D 3767.

15.6.4 Cross-Sectional Area—The cross-sectional area is calculated from the median of three measurements of radial width and thickness. For thin wall tubing, the area is calculated from the axial length of the cut section and wall thickness.

### 16. Procedure

16.1 Determination of Tensile Stress, Tensile Strength, Braking (Ultimate) Elongation and Yield Point—In testing ring specimens, lubricate the surface of the spindle with a suitable lubricant, such as mineral oil or silicone oil. Select one with documented assurance that it does not interact or affect the material being tested. The initial setting of the distance between the spindle centers may be calculated and adjusted according to the following equation:

IS=[C_{(TS)}−C_{(SP)}]/² (6)

where:
IS=initial separation of spindle centers, mm (in.),
C_{(TS)}=circumference of test specimen, inside circumference for Type 1 rings, mean circumference for Type 2 rings, mm (in.), and
C_{(SP)}=circumference of either (one) spindle, mm (in.).

Unless otherwise specified the rate of spindle separation shall be 500±50 mm/min (20±2 in./min). Start the test machine and record the force and corresponding distance between the spindles. At rupture, measure and record the ultimate (breaking) elongation and the tensile (force) strength. See Section 17 for calculations.

NOTE—When using the small ISO ring, the rate of spindle separation shall be 100±10 mm/min (4±0.4 in./min).

16.2 Tests at Temperatures Other than Standard—Use the test chamber described in 6.2 and observe the precautionary statement. For tests at temperatures above 23° C. (73.4° F.), preheat the specimens 6±2 min at the test temperature. For below room temperature tests cool the specimens at the test temperature for at least 10 min prior to test. Use test temperatures prescribed in Practice D 1349. Place each specimen in the test chamber at intervals such that the recommendations of 9.2 are followed.

### 17. Calculations

17.1 Stress-strain properties for ring specimens are in general calculated in the same manner as for dumbbell and straight specimens with one important exception. Extending a ring specimen generates a nonuniform stress (or strain) field across the width (as viewed from left to right) of each leg of the ring. The initial inside dimension (circumference) is less than the outside dimension (circumference), therefore for any extension of the grips, the inside strain (or stress) because of the differences in the initial (unstrained) dimensions.

17.2 The following options are used to calculate stress at a specified elongation (strain) and breaking or ultimate elongation.

17.2.1 Stress at a Specified Elongation—The mean circumference of the ring is used for determining the elongation. The rationale for this choice is that the mean circumference best represents the average strain in each leg of the ring.

17.2.2 Ultimate (Breaking) Elongation—This is calculated on the basis of the inside circumference since this represents the maximum strain (stress) in each leg of the ring. This location is the most probable site for the initiation of the rupture process that occurs at break.

17.3 Calculate the tensile stress at any specified elongation by using Eq 2 in 13.1.

17.3.1 The elongation to be used to evaluate the force as specified in Eq 2 (13.1), is calculated as follows:

E=200[L/MC_{(TS)}] (7)

where:
E=elongation (specified), percent,
L=increase in grip separation at specified elongation, mm (in.), and
MC_{(TS)}=mean circumference of test specimen, mm (in.).

17.3.2 The grip separation for any specified elongation can be found by rearranging Eq 7, as given below:

L=E×MC_{(TS)}/200 (8)

17.4 Calculate the yield stress by using Eq 3 in 13.2.

17.5 Evaluate the yield strain as given in 13.3. Since yield strain may be considered to be an average bulk property of any material, use the mean circumference for this evaluation.

17.6 Calculate the tensile strength by using Eq 4 in 13.4.

17.7 Calculate the breaking or ultimate elongation as follows:

E=200/[L/IC_{(TS)}] (9)

where:
E=breaking or ultimate elongation, percent,
L=increase in grip separation at break, mm (in.), and
IC_{(TS)}=inside circumference of ring test specimen, mm (in.).

17.8 The inside circumference is used for both types of rings, see 15.1.1 for dimensions. Use the inside diameter to calculate the inside circumference for Type 2 rings.

NOTE—Eq 8, Eq 9, and 10 are applicable only if the initial setting of the spindle centers is adjusted in accordance with Eq 7.

NOTE—The user of these test method should be aware that because of the different dimensions used in calculating (1) stress at a specified elongation (less than the ultimate elongation) and (2) the ultimate (breaking) elongation (see 20.1 and 20.2), it is possible that a stress at a specified elongation, slightly less (4 to 5%) than the ultimate elongation cannot be measured (calculated).

### 18. Report

18.1 Report the following information:

18.1.1 Results calculated in accordance with Section 13 or 17, whichever is applicable,

18.1.2 Type or description of test specimen and with Section 13 which type of die, either U.S. Customary Units or Metric Units, was used.

18.1.3 Date of test,

18.1.4 Rate of extension if not as specified,

18.1.5 Temperature and humidity of test room if not as specified,

18.1.6 Temperature of test if at other than 23±2° C. (73.4±3.6° F.) and

18.1.7 Date of vulcanization, preparation of the rubber, or both, if known.

### 19. Precision and Bias

19.1 This precision and bias section has been prepared in accordance with Practice D 4483. Refer to Practice D 4483 for terminology and other statistical details.

19.2 The precision results in this precision and bias section give an estimate of the precision of these test methods with the materials used in the particular interlaboratory program as described below. The precision parameters should not be used for acceptance/rejection testing of any group of materials without documentation that the parameters are applicable to those particular materials and the specific testing protocols that include these test methods.

19.3 Test Method A (Dumbbells):

19.3.1 For the main interlaboratory program a Type 1 precision was evaluated in 1986. Both repeatability and reproducibility are short term, a period of a few days separates replicate test results. A test result is the median value, as specified by this test method, obtained on three determination(s) or measurement(s) of the property or parameter in question.

19.3.2 Three different materials were used in this interlaboratory program, these were tested in ten laboratories on two different days.

19.3.3 For the main interlaboratory program cured sheets of each of the three compounds were circulated to each laboratory and stress-strain (dumbbell) specimens were cut, gaged, and tested. A secondary interlaboratory test was conducted for one of the compounds (R19160). For this testing, uncured compound was circulated and sheets were cured at a specified time and temperature (10 min at 157° C.) in each laboratory. From these individually cured sheets, test specimens were cut and tested on each of two days one week apart as in the main program. The main program results are referred to as “Test Only” and the secondary program results are referred to as “Cure and Test.”

19.3.4 The results of the precision calculations for repeatability and reproducibility are given in Tables 1 and 2, in ascending order of material average or level, for each of the materials evaluated and for each of the three properties evaluated.

19.3.5 The precision of this test method may be expressed in the format of the following statements that use what is called an “appropriate value” of r, R, (r), or (R), that is, that value to be used in decisions about test results (obtained with the test method). The appropriate value is that value of r or R associated with a mean level in Tables 1-4 closest to the mean level under consideration at any given time, for any given material in routine testing operations.

19.3.6 Repeatability—The repeatability, r, of this test method has been established as the appropriate value tabulated in Tables 1 and 2. Two single test results, obtained under normal test method procedures, that differ by more than this tabulated r (for any given level) must be considered as derived from different or nonidentical sample populations.

19.3.7 Reproducibility—The reproducibility, R, of this test method has been established as the appropriate value tabulated in Tables 1 and 2. Two single test results obtained in two different laboratories, under normal test method procedures, that differ by more than the tabulated R (for any given level) must be considered to have come from different or nonidentical sample populations.

19.3.8 Repeatability and reproducibility expressed as a percentage of the mean level, (r) and (R), have equivalent application statements as above for r and R. For the (r) and (R) statements, the difference in the two single test results is expressed as a percentage of the arithmetic mean of the two test results.

19.3.9 Bias—In test method terminology, bias is the difference between an average test value and the reference (or true) test property value. Reference values do not exist for this test method since the value (of the test property) is exclusively defined by the test method. Bias, therefore, cannot be determined.

19.4 Test Method B (Rings):

19.4.1 A Type 1 precision was evaluated in 1985. Both repeatability and reproducibility are short term, a period of a few days separates replicate test results. A test result is the mean value, as specified by this test method, obtained on three determinations or measurements of the property or parameter in question.

19.4.2 Six different materials were used in the interlaboratory program, these were tested in four laboratories on two different days.

19.4.3 The results of the precision calculations for repeatability and reproducibility are given in Tables 3 and 4, in ascending order of material average or level, for each of the materials evaluated.

TABLE 1
Type 1 (Test Only) Precision on Method A Die C Dumbbell
Test Specimens

| | | Within Laboratories | | | Between Laboratories | | |
|---|---|---|---|---|---|---|---|
| Material | Average | SR | R | (r) | SR | R | (R) |

Part 1 Tensile Strength, MPa:

| | | | | | | | |
|---|---|---|---|---|---|---|---|
| 1. N18081 | 9.88 | 0.200 | 0.568 | 5.75 | 0.293 | 0.829 | 8.40 |
| 3. E17074 | 15.38 | 0.467 | 1.323 | 8.60 | 0.482 | 1.366 | 8.88 |
| 2. R19160 | 25.70 | 0.436 | 1.235 | 4.80 | 1.890 | 5.351 | 20.82 |
| Pooled | 16.99 | 0.385 | 1.090 | 6.42 | 1.102 | 3.120 | 18.37 |
| Values^{A} | | | | | | | |

Part 2 Percent Elongation:

| | | | | | | | |
|---|---|---|---|---|---|---|---|
| 3. E17074 | 156.3 | 6.304 | 17.842 | 11.41 | 11.481 | 32.492 | 20.78 |
| 2. R19160 | 510.4 | 11.471 | 32.464 | 6.36 | 21.243 | 60.120 | 11.77 |
| 1. N18081 | 591.6 | 17.810 | 50.402 | 8.52 | 27.198 | 76.972 | 13.01 |
| Pooled | 419.4 | 12.761 | 36.114 | 8.61 | 20.999 | 59.427 | 14.16 |
| Values^{A} | | | | | | | |

Part 3 Stress at 100% Elongation, MPa:

| | | | | | | | |
|---|---|---|---|---|---|---|---|
| 1. N18081 | 1.17 | 0.053 | 0.151 | 12.96 | 0.061 | 0.1744 | 14.92 |
| 2. $19160 | 2.01 | 0.050 | 0.142 | 7.10 | 0.274 | 0.7755 | 38.62 |
| 3. E17074 | 9.08 | 0.489 | 1.385 | 15.25 | 0.738 | 2.0910 | 23.02 |
| Pooled | 4.09 | 0.285 | 0.808 | 19.79 | 0.456 | 1.2915 | 31.60 |
| Values^{A} | | | | | | | |

^{A}No values omitted.
Note:
SR = repeatability standard deviation.
r = repeatability = 2.83 times the square root of the repeatability variance.
(r) = repeatability (as percentage of material average).
SR = reproducibility standard deviation.
R = reproducibility = 2.83 times the square root of the reproducibility variance.
(R) = reproducibility (as percentage of material average).

TABLE 2
Type 1 (Cure and Test) Precision on Method A Die C Dumbbell Test
Specimens

| | | Within Laboratories | | | Between Laboratories | | |
|---|---|---|---|---|---|---|---|
| Material | Average | SR | R | (r) | SR | R | (R) |

Part 1 Tensile Strength, MPa:

| | | | | | | | |
|---|---|---|---|---|---|---|---|
| 1. R19160 | 26.0 | 0.613 | 1.73 | 6.66 | 1.74 | 4.95 | 19.0 |

Part 2 Percent Elongation:

| | | | | | | | |
|---|---|---|---|---|---|---|---|
| 1. R19160 | 526.9 | 13.32 | 37.7 | 7.15 | 19.6 | 55.70 | 10.5 |

Part 3 Stress at 100% Elongation, MPa:

| | | | | | | | |
|---|---|---|---|---|---|---|---|
| 1. R19160 | 1.83 | 0.072 | 0.205 | 11.21 | 0.226 | 0.641 | 34.5 |

Note 1:
SR = repeatability standard deviation.
r = repeatability = 2.83 times the square root of the repeatability variance.
(r) = repeatability (as percentage of material average).
SR = reproducibility standard deviation.
R = reproducibility = 2.83 times the square root of the reproducibility variance.
(R) = reproducibility (as percentage of material average).
Note 2:
N18081-highly extended, low durometer CR (Neoprene)
R19160-high tensile NR.
E17047-moderately filled EPDM.

TABLE 3
Type 1 Precision-Test Method B (Rings)
Tensile Strength (MPa)

| | | Within Laboratories | | | Between Laboratories | | |
|---|---|---|---|---|---|---|---|
| Material | Average | SR | R | (r) | SR | R | (R) |
| 5. MATL 5 | 11.5 | 0.666 | 1.885 | 16.3 | 1.43 | 4.06 | 35.3 |
| 6. MATL 6 | 12.7 | 0.274 | 0.775 | 6.0 | 0.83 | 2.35 | 18.5 |
| 1. MATL 1 | 14.6 | 0.367 | 1.040 | 7.1 | 0.40 | 1.15 | 7.9 |
| 4. MATL 4 | 15.0 | 0.553 | 1.565 | 10.4 | 3.03 | 8.59 | 57.2 |
| 2. MATL 2 | 20.3 | 1.293 | 3.660 | 18.0 | 2.47 | 6.99 | 34.4 |
| 3. MATL 3 | 22.3 | 1.556 | 4.405 | 19.6 | 1.55 | 4.40 | 19.6 |
| Pooled Values^{A} | 15.9 | 0.942 | 2.666 | 16.7 | 1.87 | 5.31 | 33.3 |

^{A}No values omitted.
Note:
SR = repeatability standard deviation.
r = repeatability = 2.83 times the square root of the repeatability variance.
(r) = repeatability (as percentage of material average).
SR = reproducibility standard deviation.
R = reproducibility = 2.83 times the square root of the reproducibility variance.
(R) = reproducibility (as percentage of material average).

TABLE 4
Type 1 Precision-Test Method B (Rings)
Ultimate Elongation, %

| | | Within Laboratories | | | Between Laboratories | | |
|---|---|---|---|---|---|---|---|
| Material | Average | SR | R | (r) | SR | R | (R) |
| 1. MATL 1 | 322.1 | 15.25 | 43.18 | 13.40 | 33.4 | 94.7 | 29.4 |
| 2. MATL 2 | 445.4 | 11.35 | 32.12 | 7.21 | 34.1 | 96.6 | 21.7 |
| 4. MATL 4 | 509.4 | 27.44 | 77.65 | 15.24 | 51.1 | 144.8 | 28.4 |
| 5. MATL 5 | 545.0 | 2.91 | 8.25 | 1.51 | 56.3 | 159.5 | 29.2 |
| 6. MATL 6 | 599.7 | 12.91 | 36.55 | 6.09 | 14.0 | 39.6 | 6.60 |
| 3. MATL 3 | 815.8 | 16.25 | 45.99 | 5.63 | 90.6 | 256.5 | 31.4 |
| Pooled Values^{A} | 539.6 | 16.54 | 46.82 | 8.67 | 48.2 | 136.4 | 25.2 |

^{A}No values omitted.
Note:
SR = repeatability standard deviation.
r = repeatability = 2.83 times the square root of the repeatability variance.
(r) = repeatability (as percentage of material average).
SR = reproducibility standard deviation.
R = reproducibility = 2.83 times the square root of the reproducibility variance.
(R) = reproducibility (as percentage of material average).

19.4.4 Repeatability, r, varies over the range of material levels as evaluated. Reproducibility, R, varies over the range of material levels as evaluated.

19.4.5 The precision of this test method may be expressed in the format of the following statements that use what is called an “appropriate value” of r, R, (r), or (R), that is, that value to be used in decisions about test results (obtained with the test method). The appropriate value is that value of r or R associated with a mean level in Tables 1-4 closest to the mean level under consideration at any given time, for any given material in routine testing operations.

19.4.6 Repeatability—The repeatability, r, of this test method has been established as the appropriate value tabulated in Tables 3 and 4. Two single test results, obtained under normal test method procedures, that differ by more than this tabulated r (for any given level) must be considered as derived from different or nonidentical sample populations.

19.4.7 Reproducibility—The reproducibility, R, of this test method has been established as the appropriate value tabulated in Tables 3 and 4. Two single test results obtained in two different laboratories, under normal test method procedures, that differ by more than the tabulated R (for any given level) must be considered to have come from different or nonidentical sample populations.

19.4.8 Repeatability and reproducibility expressed as a percentage of the mean level, (r) and (R), have equivalent application statements as 19.3.6 and 19.3.7 for r and R. For the (r) and (R) statements, the difference in the two single test results is expressed as a percentage of the arithmetic mean of the two test results.

19.4.9 Bias—In test method terminology, bias is the difference between an average test value and the reference (or true) test property value. Reference values do not exist for this test method since the value (of the test property) is exclusively defined by the test method. Bias, therefore, cannot be determined.

### 20. Keywords

20.1 elongation; set after break; tensile properties; tensile set; tensile strength; tensile stress; yield point

### European Standard EN 455-2

### October 2000

Medical Gloves for Single Use—Part 2: Requirements and Testing for Physical Properties (including Technical Corrigendum 1:1996)

### 1 Scope

This Part of this standard specifies requirements and gives test methods for physical properties of single-use medical gloves (i.e. surgical gloves and examination/procedure gloves) in order to ensure that they provide and maintain in use an adequate level of protection from cross-contamination from both patient and user.

2 Normative references

This European Standard incorporates by dated or undated reference, provisions from other publications. These normative references are cited at the appropriate places in the text and the publications are listed hereafter. For date references, subsequent amendments to or revisions of any of these publications apply to this European Standard only when incorporated in it by amendment or revision. For undated references the latest edition of the publication referred to applies (including amendments).

### ISO 188

Rubber, vulcanized or thermoplastic—Accelerated ageing and heat resistance tests.

### ISO 4648

Rubber, vulcanized or thermoplastic —Determination of dimensions of test pieces and products for test purposes.

### 3 Terms and Definitions

For the purposes of this standard the following terms and definitions apply.

3.1

### Medical Gloves for Single Use

Gloves intended for use in the medical field to protect patient and user from cross-contamination

3.2

### Surgical Gloves

Sterile, anatomically shaped medical gloves with the thumb positioned towards the palmar surface of the index finger rather than laying flat, and intended for use in invasive surgery

3.3

### Examination/Procedure Gloves

Sterile or non-sterile medical gloves, which may or may not be anatomically shaped, intended for conducting medical examinations, diagnostic and therapeutic procedures and for handling contaminated medical material

3.4

### Long-Cuff Medical Gloves

a) surgical gloves having a minimum overall length of 300 mm
b) examination/procedure gloves having a minimum overall length of 270 mm
   3.5

### Seamed Medical Gloves; Welded Gloves

Medical gloves manufactured by welding or otherwise bonding together flat films of material

### 4 Dimensions

### 4.1 General

When measured as described in 4.2 and 4.3 taking 13 samples from each lot, the median value obtained for the dimensions shall be as given in Table 1 and Table 2.

### 4.2 Length

Measure the length by freely suspending the glove with the middle finger on a vertical graduated rule having a rounded tip so as to fit the shape of the finger tip of the glove. Remove wrinkles and folds without stretching the glove. Record the minimum measured length.
NOTE For greater ease of measurement, the rule may be angled backwards slightly so that the glove is in contact with the rule.

### 4.3 Width

Measure the width (dimension w as designated in FIG. 1), to the nearest millimetre, using a rule, with the glove placed on a flat surface. Do not stretch the glove.

TABLE 1
Dimensions of surgical gloves

| | Minimum length¹⁾ | Width^{2),3)} |
|---|---|---|
| Size | mm | mm |
| 5 | 250 | 67 ± 4 |
| 5.5 | 250 | 72 ± 4 |
| 6 | 260 | 77 ± 5 |
| 6.5 | 260 | 83 ± 5 |
| 7 | 270 | 89 ± 5 |
| 7.5 | 270 | 95 ± 5 |
| 8 | 270 | 102 ± 6 |
| 8.5 | 280 | 108 ± 6 |
| 9 | 280 | 114 ± 6 |
| 9.5 | 280 | 121 ± 6 |

¹⁾Dimension I as designated.
²⁾Dimension w as designated.
³⁾The width requirements are for gloves made from natural rubber latex, synthetic rubber latex or solutions of natural and/or synthetic rubber. These dimensions may not be appropriate for gloves made from other materials.

TABLE 2
Dimensions of examination/procedure gloves

Minimum length¹⁾
mm

| | Seamed | Unseamed | Width^{2),3)} |
|---|---|---|---|
| Size | gloves | gloves | mm |
| Extra Small | 270 | 240 | ≦80 |
| Small | 270 | 240 | 80 ± 10 |
| Medium | 270 | 240 | 95 ± 10 |
| Large | 270 | 240 | 110 ± 10 |
| Extra Large | 270 | 240 | ≧110 |

¹⁾Dimension I as designated
²⁾Dimension w as designated
³⁾The width requirements are for gloves made from natural rubber latex, synthetic rubber latex or solutions of natural and/or synthetic rubber. These dimensions may not be appropriate for gloves made from other materials.

### 5. Strength

### 5.1 General

When the strength of the glove is tested as described in 5.2, 5.3 and, if appropriate, 5.4 at a temperature of (23±2)° C. and a relative humidity of (50±5) % r.h. the force at break of seamed and unseamed gloves shall be as given in Table 3.

### 5.2 Force at Break Before Accelerated Ageing

5.2.1 Obtain one dumbbell test piece from each of 13 gloves (from 7 pairs of gloves where applicable) using a cutter as specified in FIG. 2 from the palm, back of the hand or cuff areas of each glove in the test sample, avoiding textured areas if possible and taking the test pieces in the direction of the longitudinal axis of the glove.

5.2.2 Determine the force at break of the 13 test pieces after conditioning for a minimum of 16 hours under ambient conditions of (23±2)° C. and a relative humidity of (50±5) % and cross-head speed of 500 mm/min.
NOTE—If a test piece breaks at the shoulder, it is not necessary to repeat the test on another test piece.
   5.2.3
a) Determine the single wall thickness (t_{f}) of the same glove as in 5.2.1 at a point on the middle finger within (13±3) mm of the finger tip by measuring the double wall thickness as described in method A1 of ISO 4648, using a gauge with a foot pressure of (22±5) kPa. Take the single wall thickness as one half of the measured double wall thickness.
b) Measure the thickness of the dumbbell test pieces (tₓ) as described in method A1 of ISO 4648, using the gauge described in 5.2.3 a).
c) Compare the values of t_{f} and tₓ. If t_{f}/tₓ≧0.9, no correction to the measured force at break is necessary. If tf/tx<0.9, correct the measured value by multiplying the measured force at break (see 5.2.2) by a factor of t_{f}/tₓ.
   NOTE—Although there is no requirement for thickness in this standard, it is recognized that the fingers of a glove may, because of design or manufacturing processes, be significantly thinner and therefore weaker in terms of force to break than at the points from which the test pieces were taken. It is important to ensure that the minimum force at break requirements given in Table 3 are maintained at the fingertips. If the difference in thickness between the fingertip and the point from which the test pieces were taken is small (less than 10%), no correction is necessary. If this difference is greater than 10%, a correction factor based on the relative thickness is applied to the measured force at break to obtain a true estimate of the strength of the glove at the fingertip.

5.2.4 Record the force at break, in Newtons, for each of the 13 samples, corrected as described in 5.2.3 if necessary. The median of the recorded results shall comply with the values of Table 3.

### 5.3 Force a Break After Accelerated Ageing

5.3.1 Place gloves packaged in unit packages or gloves taken from bulk packages for a period of 7 days at a temperature of (70±2)° C. in an oven as specified in ISO 188.

5.3.2 Measure the force at break as described in 5.2.

### 5.4 Seamed Gloves

5.4.1 Obtain one dumbbell test piece using a cutter from each of 13 gloves in the test sample such that the seam is present within the length of the narrow parallel portion of the test piece and is at right angles to the long axis of the test piece.

5.4.2 Determine the force at break of the 13 test pieces as described in 5.2.2.

5.4.3 Record the median force at break, in Newtons, of the 13 obtained samples.

5.4.4 Repeat 5.4.1, 5.4.2 and 5.4.3 on gloves that have been aged as described in 5.3.1.

TABLE 3
The median values of force at break

| | | | Examination/ | |
|---|---|---|---|---|
| | Surgical | | Procedure | |
| | Gloves | | gloves | |
| | Newtons | | Newtons | |
| | a) | b) | c) | d) |
| Before accelerated ageing | ≧12 | ≧9 | ≧9 | ≧3.6 |
| After accelerated ageing | ≧9 | ≧6 | ≧6 | ≧3.6 |
| Seam of seamed gloves before | ≧12 | ≧9 | ≧9 | ≧3.6 |
| accelerated ageing | | | | |
| Seam of seamed gloves after | ≧9 | ≧6 | ≧6 | ≧3.6 |
| accelerated ageing | | | | |

a) Requirements for gloves made from natural rubber latex.
b) Requirements for gloves made from synthetic rubber latex or solutions of natural or synthetic rubber
c) Requirements for gloves made from natural rubber latex, synthetic rubber latex or solutions of natural and/or synthetic rubber
d) Requirements for gloves made from other materials.

6 Test report

Any test report shall include at least the following information:
reference to this part of EN 455;
the type of glove and the manufacturing batch code;
the name and address of the manufacturer or distributor and test laboratory, if different;
the date of testing performed;
the test results.

Although specific embodiments of the present invention are herein illustrated and described in detail, the invention is not limited thereto. The above detailed descriptions are provided as exemplary of the present invention and should not be construed as constituting any limitation of the invention. Modifications will be obvious to those skilled in the art, and all modifications that do not depart from the spirit of the invention are intended to be included with the scope of the appended claims.

1. An article of manufacture comprising a synthetic elastomer, wherein the article of manufacture possesses a SCI₁₀₀ greater than or equal to about 190 mm⁻¹, wherein the SCI₁₀₀ value is calculated by measuring the tensile strength of an article relative to its resistance to deformation according to the ratio:
$$\frac{{T}_{b}}{{T}_{x} \times {t}_{0}}$$
where T_{b} is the tensile strength of the article, Tₓ is the tensile stress at x % elongation, x is 100, and t₀ is the thickness of the unstrained specimen, T_{b}, Tₓ, and t₀ are all measured following ASTM D-412, and the strength-comfort index, or SCIₓ, is defined as:
$${SCI}_{x} = \frac{{T}_{b}}{{T}_{x} \times {t}_{0}} .$$

2. An article of manufacture as in claim 1 wherein the article of manufacture possesses a SCI₁₀₀ greater than or equal to about 200 mm⁻¹, about 225 mm⁻¹, or about 250 mm⁻¹.

3. An article of manufacture as claimed in claim 1, wherein the synthetic elastomer is prepared as an aqueous dispersion.

4. An article of manufacture as claimed in claim 1, wherein the synthetic elastomer is prepared by emulsion polymerization.

5. An article of manufacture as claimed in claim 1, wherein the synthetic elastomer comprises a C₄ to C₉ diene.

6. An article of manufacture as claimed in claim 1, wherein the synthetic elastomer is prepared from a monomer mixture comprising 1,3-butadiene.

7. An article of manufacture as claimed in claim 1, wherein the synthetic elastomer is prepared from a monomer mixture comprising acrylonitrile.

8. An article of manufacture as claimed in claim 1, wherein the thickness of the article is less than or equal to about 0.09 mm.

9. An article of manufacture as claimed in claim 1, wherein the tensile strength is measured from a sample cut from Die C or Die D.

10. An article of manufacture as claimed in claim 1, wherein the article is made using a dipping process.

11. An article of manufacture as claimed in claim 1, wherein the article is a glove.

12. An article of manufacture as claimed in claim 1, wherein the article possesses a tensile strength greater than or equal to 14 MPa and an ultimate elongation of greater than or equal to 500% when measured following ASTM D-412.

13. An article of manufacture as claimed in claim 1, wherein the article possesses a force at break greater than or equal to 9 N when measured following EN 455-2.

14. A method of preparing a synthetic polymer film with a SCI₁₀₀ greater than 190 mm⁻¹, comprising:
a) identifying a polymer composition or set of polymer compositions that can be compounded to provide various values for tensile strength and tensile stress, and
b) preparing polymer films that balance the tensile strength, tensile stress, and film thickness, optionally by adjusting the compounding and processing conditions to which the polymer composition or set of polymer compositions is subjected, such that the SCI₁₀₀ has a value greater than or equal to 190 mm⁻¹, wherein the SCI₁₀₀ value is calculated by measuring the tensile strength of an article relative to its resistance to deformation according to the ratio:
$$\frac{{T}_{b}}{{T}_{x} \times {t}_{0}}$$
where T_{b} is the tensile strength of the article, Tₓ is the tensile stress at x % elongation, x is 100, and to is the thickness of the unstrained specimen, T_{b}, Tₓ, and t₀ are all measured following ASTM D-412, and the strength-comfort index, or SCIₓ, is defined as:
$${SCI}_{x} = \frac{{T}_{b}}{{T}_{x} \times {t}_{0}} .$$

15. The method of claim 14, wherein the polymer film possesses a SCI₁₀₀ greater than or equal to about 200 mm⁻¹, about 225 mm⁻¹, or about 250 mm⁻¹.

16. A method of preparing a synthetic polymer glove according to claim 14 comprising:
c) using an unglazed smooth surface ceramic glove former;
d) heating said glove former to a temperature of between about 70 and about 120° C. followed by dipping the heated glove former into an aqueous coagulant comprising about 20-about 35% calcium nitrate, and removing the glove former from the coagulant with an exit speed between about 2 and about 30 mm/s; and drying the glove former wet with coagulant at about 70-about 120° C. for about 30-about 60 seconds, followed by dipping the former into a carboxylated nitrile latex compound with an entry speed of about 15-about 100 mm/s, a dwell time of 0-about 10 seconds, and an exit speed of about 15-about 30 mm/s, wherein said carboxylated nitrile latex compound has a pH of above about 8.8, a non-volatile content of about 15-about 30%, comprises about 0.6-about 1 phr zinc oxide, and a temperature of about 15-about 40° C.
